(19) United States
(12) Patent Application Publication
(10) Pub. No.: US 2022/0224918 A1
(43) Pub. Date: Jul. 14, 2022

(54) VIDEO TRANSPORT SYSTEM, VIDEO TRANSMISSION DEVICE, VIDEO RECEPTION DEVICE, VIDEO DISTRIBUTION METHOD, VIDEO TRANSMISSION METHOD, VIDEO RECEPTION METHOD, AND NON-TRANSITORY COMPUTER READABLE RECORDING MEDIUM

(71) Applicant: Sumitomo Electric Industries, Ltd., Osaka-shi, Osaka (JP)

(72) Inventor: Naoki MAEDA, Osaka-shi, Osaka (JP)

(73) Assignee: Sumitomo Electric Industries, Ltd., Osaka-shi, Osaka (JP)

(21) Appl. No.: 17/614,373

(22) PCT Filed: May 14, 2020
(86) PCT No.: PCT/JP2020/019202

§ 371 Date: Nov. 26, 2021

(30) Foreign Application Priority Data
May 29, 2019 (JP) 2019-100291

(51) Int. Cl. H04N 19/167; H04N 19/70; H04N 19/172

(52) U.S. Cl. CPC H04N 19/167; H04N 19/172; H04N 19/70

(57) ABSTRACT

A video transport system includes a video transmission device that performs compression processing on video data and transmits the video data subjected to compression processing and a video reception device that receives the video data subjected to compression processing from the video transmission device and performs decompression processing on the received video data. Of a prescribed attention area within a frame of the video data and a prescribed non-attention area different from the attention area within the frame, the video transmission device performs prescribed compression processing within the frame on the non-attention area and does not perform the prescribed compression processing on the attention area.

### TECHNICAL FIELD

The present disclosure relates to a video transport system, a video transmission device, a video reception device, a video distribution method, a video transmission method, and a computer program.

The present application claims priority to Japanese Patent Application No. 2019-100291 filed on May 29, 2019, the entire contents of which are herein incorporated by reference.

### BACKGROUND ART

For broadcasting and the like, a technique for transporting high-definition video data of ultra-high resolution such as 8K ultra high definition television (UHDTV) (which will be abbreviated as “8K” below) has been developed (see, for example, NPL 1).

Video images of ultra-high resolution, owing to expressive power thereof, are expected to increasingly be used in the future in every field such as surveillance applications, crime prevention applications, and applications for visual inspection of buildings and the like. Such expressive power, on the other hand, requires a high-rate communication path for transport of video data because a rate of transport therefor is, for example, several ten gigabits per second (Gbps) or higher.

### CITATION LIST

### Patent Literature

NPL 1: “Wikipedia”, [online], [searched on Apr. 8, 2019], the Internet <URL:http://ja.wikipedia.org/wiki/H.265>

NPL 2: “Shisen Kenshutsu Gijutsu Kihon Genri (basic principles of line-of-sight detection technique),” [online], Apr. 23, 2013, Fujitsu Laboratories, Ltd., [searched on Jan. 6, 2020], the Internet <URL:
https://www.fujitsu.com/jp/group/labs/resources/tech/techguide/list/eye-movements/p03.html>

### SUMMARY OF INVENTION

A video transport system according to one embodiment of the present disclosure includes a video transmission device that performs compression processing on video data and transmits the video data subjected to the compression processing and a video reception device that receives the video data subjected to the compression processing from the video transmission device and performs decompression processing on the received video data. Of a prescribed attention area within a frame of the video data and a prescribed non-attention area different from the attention area within the frame, the video transmission device performs prescribed compression processing within the frame on the non-attention area and does not perform the prescribed compression processing on the attention area.

A video transmission device according to another embodiment of the present disclosure includes a compression processing unit that performs, of a prescribed attention area within a frame of video data and a prescribed non-attention area different from the attention area within the frame, prescribed compression processing within the frame on the non-attention area and a transmitter that transmits the video data subjected to the prescribed compression processing to a video reception device.

A video reception device according to another embodiment of the present disclosure includes a receiver that receives video data from a video transmission device, the video data being video data resulting from prescribed compression processing within a frame of the video data on a prescribed non-attention area, of a prescribed attention area within the frame and the non-attention area different from the attention area within the frame, and a decompressor that decompresses the video data received by the receiver.

A video distribution method according to another embodiment of the present disclosure includes performing compression processing, by a video transmission device, on video data and transmitting, by the video transmission device, the video data subjected to the compression processing, and receiving, by a video reception device, the video data subjected to the compression processing from the video transmission device and performing, by the video reception device, decompression processing on the received video data. In the transmitting the video data, of a prescribed attention area within a frame of the video data and a prescribed non-attention area different from the attention area within the frame, the video transmission device performs prescribed compression processing within the frame on the non-attention area and does not perform the prescribed compression processing on the attention area.

A video transmission method according to another embodiment of the present disclosure includes performing, of a prescribed attention area within a frame of video data and a prescribed non-attention area different from the attention area within the frame, prescribed compression processing within the frame onto the non-attention area and transmitting the video data subjected to the prescribed compression processing to a video reception device.

A video reception method according to another embodiment of the present disclosure includes receiving video data from a video transmission device, the video data being video data resulting from prescribed compression processing within a frame of the video data on a prescribed non-attention area, of a prescribed attention area within the frame and the non-attention area different from the attention area within the frame, and decompressing the video data received by a receiver.

A computer program according to another embodiment of the present disclosure causes a computer to perform performing, of a prescribed attention area within a frame of video data and a prescribed non-attention area different from the attention area within the frame, prescribed compression processing within the frame on the non-attention area, and transmitting the video data subjected to the prescribed compression processing to a video reception device.

A computer program according to another embodiment of the present disclosure causes a computer to perform receiving video data from a video transmission device, the video data being video data resulting from prescribed compression processing within a frame of the video data on a prescribed non-attention area, of a prescribed attention area within the frame and the non-attention area different from the attention area within the frame, and decompressing the video data received by a receiver.

Naturally, the computer program can be distributed in a non-transitory computer readable recording medium such as a compact disc-read only memory (CD-ROM) or over a communication network such as the Internet. The present disclosure can also be implemented as a semiconductor integrated circuit that implements a part or the entirety of a video transmission device or a video reception device.

### BRIEF DESCRIPTION OF DRAWINGS

FIG. 1 is a diagram showing an overall configuration of a video transport system according to a first embodiment of the present disclosure.

FIG. 2 is a block diagram showing a configuration of a video transmission device according to the first embodiment of the present disclosure.

FIG. 3 is a diagram showing exemplary image data.

FIG. 4 is a diagram showing exemplary image data after the image data shown in FIG. 3 is divided into small blocks.

FIG. 5 is a diagram for illustrating an order of output of small blocks from a block divider to a subtractor and an area designation unit.

FIG. 6 is a diagram for illustrating subtraction processing.

FIG. 7 is a diagram showing block information for one frame (image data) determined by an area determination unit.

FIG. 8 is a diagram showing exemplary down-conversion processing.

FIG. 9 is a diagram for illustrating processing performed by the area designation unit, a down-converter unit, and a video image alignment unit.

FIG. 10 is a diagram for illustrating processing performed by the area designation unit, the down-converter unit, and the video image alignment unit.

FIG. 11 is a block diagram showing a configuration of a video reception device according to the first embodiment of the present disclosure.

FIG. 12 is a diagram showing exemplary compressed video data.

FIG. 13 is a sequence diagram showing an exemplary procedure of processing by the video transport system.

FIG. 14 is a flowchart showing details of compression processing (step S2 in FIG. 13).

FIG. 15 is a flowchart showing details of decompression processing (step S6 in FIG. 13).

FIG. 16 is a flowchart showing details of compression processing (step S2 in FIG. 13) performed by the video transmission device.

FIG. 17 is a diagram for illustrating processing performed by the area designation unit, the down-converter unit, and the video image alignment unit.

FIG. 18 is a flowchart showing details of compression processing (step S2 in FIG. 13) performed by the video transmission device.

FIG. 19 is a block diagram showing a configuration of a video transmission device according to a fourth embodiment of the present disclosure.

FIG. 20 is a block diagram showing a configuration of a video reception device according to the fourth embodiment of the present disclosure.

FIG. 21 is a sequence diagram showing an exemplary procedure of processing by the video transport system.

FIG. 22 is a flowchart showing details of compression processing (step S2 in FIG. 21).

FIG. 23 is a diagram showing exemplary compressed video data.

FIG. 24 is a diagram showing an overall configuration of a video transport system according to a fifth embodiment of the present disclosure.

FIG. 25 is a diagram showing an exemplary display and an exemplary camera.

FIG. 26 is a block diagram showing a configuration of a video reception device according to the fifth embodiment of the present disclosure.

FIG. 27 is a diagram for illustrating a method of determining an attention area.

FIG. 28 is a sequence diagram showing an exemplary procedure of processing by the video transport system.

FIG. 29 is a flowchart showing details of attention area determination processing (step S52 in FIG. 28).

FIG. 30 is a diagram schematically showing video shooting by a drone.

FIG. 31 is a diagram schematically showing a controller for operating a drone and a user who operates the controller.

FIG. 32 is a diagram schematically showing the controller for operating the drone and the user who operates the controller.

FIG. 33 is a flowchart showing details of attention area determination processing (step S52 in FIG. 28) according to a sixth embodiment of the present disclosure.

FIG. 34 is a diagram showing an exemplary display and an exemplary camera.

FIG. 35 is a diagram for illustrating a method of determining an attention area.

FIG. 36 is a diagram for illustrating a method of determining an attention area and a non-attention area.

### DETAILED DESCRIPTION

[Problem to be Solved by the Present Disclosure]

For example, usage such as transmission of video data taken by a camera (which is referred to as a “8K camera” below) that is provided in a mobile body such as heavy equipment (a crane or a crawler dozer), a drone, or a robot and is capable of taking 8K video data from a video transmission device to a video reception device and checking of the video data at a remote location is also envisioned.

Transport capability of wireless communication under “the fifth generation mobile communication system” (which is abbreviated as “5G” (5th generation) below), however, is about several Gbps. Transport of video data adapted to an 8K dual green system requires transport capability around 24 Gbps. Therefore, it is difficult to transmit 8K video data in a format as it is through 5G wireless communication. A similar problem occurs also in transmission of 8K video data by using a network protocol of 10-gigabit Ethernet™.

Video data may be transported as being compressed with such a system as H.265 (ISO/IEC 23008-2 HEVC) used in broadcast and the like. A time period of approximately several seconds, however, is required for compression processing and decompression processing, and hence video images may be delayed.

Transported video data is used, for example, for surveillance applications for checking a suspicious individual, a flow of people, or attendees. Specifically, by subjecting video data to image recognition processing, an object to be recognized such as a suspicious individual is extracted. An important area in the video data in the surveillance applications is an area around the object to be recognized, and a resolution of an area other than that may be lowered. In an application other than the above as well, a resolution of an area other than an area to which attention should be paid may be lowered.

The present disclosure was made in view of such circumstances, and an object thereof is to provide a video transport system, a video transmission device, a video reception device, a video distribution method, a video transmission method, a video reception method, and a computer program that allow low-latency distribution of video data, identicalness of which with original video images is held in an attention area.

[Advantageous Effect of the Present Disclosure]

According to the present disclosure, low-latency distribution of video data, identicalness of which with original video images is held in an attention area, can be achieved.

### Overview of Embodiments of the Present Disclosure

Overview of embodiments of the present disclosure will initially be listed and described.

(1) A video transport system according to one embodiment of the present disclosure includes a video transmission device that performs compression processing on video data and transmits the video data subjected to the compression processing and a video reception device that receives the video data subjected to the compression processing from the video transmission device and performs decompression processing on the received video data. Of a prescribed attention area within a frame of the video data and a prescribed non-attention area different from the attention area within the frame, the video transmission device performs prescribed compression processing within the frame on the non-attention area and does not perform the prescribed compression processing on the attention area.

According to this configuration, prescribed compression processing is not performed on an attention area within a frame of video data but prescribed compression processing is performed on a non-attention area, and then compressed video data can be transmitted. Therefore, identicalness with original video images is held in the attention area. The prescribed compression processing is compression processing within the frame. Therefore, delay of video images caused in H.265 in which compression processing is performed between frames is less likely. Therefore, low-latency distribution of video data can be achieved.

(2) Preferably, the attention area is determined based on a line-of-sight position of a user within the frame.

According to this configuration, for example, an area in the vicinity of a line-of-sight position of a user within the frame is defined as the attention area, and an area other than that is defined as the non-attention area. Therefore, identicalness with original video images is held in an area within the frame watched by a user, and prescribed compression processing is performed on an area not watched by the user. Therefore, compression and low-latency distribution of video data can be achieved without giving uncomfortable feeling to the user who watches the frame.

(3) Further preferably, the attention area is fixed for a prescribed time period based on a time period for which the line-of-sight position is maintained within a prescribed area.

According to this configuration, as the user gazes a prescribed position within the frame or a position in the vicinity of the prescribed position, the attention area can be fixed for a prescribed time period. The position in the vicinity of the prescribed position means, for example, a position within a prescribed distance from the prescribed position. The attention area thus remains fixed even when the user gazes the position and thereafter momentarily averts his/her eyes. Therefore, when the user moves his/her line of sight back to the original position, the user can immediately watch the video images identicalness of which with original video images is held.

(4) There may be a plurality of users, and the attention area may be determined for each user.

According to this configuration, the attention area is determined for each user based on the line-of-sight position of the user. Therefore, even when a plurality of users are watching different positions on the same frame, areas in the vicinity of the line-of-sight positions of the users are defined as the attention areas, respectively, and identicalness with original video images is held in each attention area. Therefore, the plurality of users do not feel uncomfortable.

(5) The video transmission device may change a size of the attention area in accordance with transmission condition information representing a condition of transmission of the video data subjected to the compression processing.

According to this configuration, for example, when a rate of transport of video data is lowered, a size of video data can be reduced by reducing a size of the attention area. Low-latency distribution of video data can thus be achieved.

(6) The video data may be generated by a camera mounted on a mobile body, and the attention area may be determined based on a direction of travel of the mobile body.

According to this configuration, low-latency distribution of video data identicalness of which with original video images is held in the attention area determined based on a direction of travel of the mobile body can be achieved. Thus, for example, the mobile body can fly in a stable manner.

(7) The video data may include an image of an object of visual inspection, and the attention area may be an area including a portion to be inspected of the object.

According to this configuration, low-latency distribution of video data identicalness of which with original video images is held at a portion to be inspected of an object of visual inspection can be achieved. Therefore, visual inspection of an object can be conducted with less delay.

(8) The attention area may be determined based on an amount of variation in luminance value between frames of the video data.

According to this configuration, for example, a portion where an amount of variation in luminance value between frames is large can preferentially be set as the attention area. Thus, for example, when video data is used in surveillance applications, an area including a suspicious individual can be set as the attention area and image recognition processing can efficiently be performed.

(9) The video reception device may transmit information for designating the attention area to the video transmission device.

According to this configuration, low-latency distribution of video data identicalness of which with original video images is held in a designated area can be achieved. For example, when video data is used in surveillance applications in which an area to be monitored is known in advance, surveillance processing can efficiently be performed as the user designates the area to be monitored as the attention area.

(10) The prescribed compression processing may be processing for reducing a color depth of each pixel within the non-attention area.

According to this configuration, since a color depth of each pixel in the non-attention area can be lowered, low-latency distribution of video data can be achieved. Since the non-attention area corresponds to a periphery of a field of view of a user, the user is less likely to notice reduction in color depth even though it occurs.

(11) The frame may be divided into a plurality of blocks, and the attention area and the non-attention area may be designated in a unit of a block.

According to this configuration, prescribed compression processing can be performed in a unit of a block. Compression processing can thus quickly be performed.

(12) The prescribed compression processing may be down-conversion processing for each block within the non-attention area.

According to this configuration, since a resolution within the non-attention area can be lowered, low-latency distribution of video data can be achieved.

(13) The non-attention area may include a plurality of areas different in compression rate in the prescribed compression processing, and an area adjacent to the attention area among the plurality of areas may be lowest in compression rate.

According to this configuration, compression processing can be performed with a compression rate in an area in the non-attention area closer to a center of the field of view of a user being lower and with the compression rate in an area farther from the center being higher. Therefore, low-latency distribution of video data can be achieved while sudden change in how video images look at a portion of boundary between the attention area and the non-attention area is prevented.

(14) A video transmission device according to another embodiment of the present disclosure includes a compression processing unit that performs, of a prescribed attention area within a frame of video data and a prescribed non-attention area different from the attention area within the frame, prescribed compression processing within the frame onto the non-attention area and a transmitter that transmits the video data subjected to the prescribed compression processing to a video reception device.

According to this configuration, prescribed compression processing is not performed on an attention area within a frame of video data but prescribed compression processing is performed on a non-attention area, and then compressed video data can be transmitted. Therefore, identicalness with original video images is held in the attention area. The prescribed compression processing is compression processing within the frame. Therefore, delay of video images caused in H.265 in which compression processing is performed between frames is less likely. Therefore, low-latency distribution of video data can be achieved.

(15) A video reception device according to another embodiment of the present disclosure includes a receiver that receives video data from a video transmission device, the video data being video data resulting from prescribed compression processing within a frame of video data on a prescribed non-attention area, of a prescribed attention area within the frame and the non-attention area different from the attention area within the frame, and a decompressor that decompresses the video data received by the receiver.

According to this configuration, compressed video data for which prescribed compression processing is not performed on an attention area within a frame of video data but prescribed compression processing has been performed on a non-attention area can be received. Therefore, identicalness with original video images is held in the attention area. Prescribed compression processing within the frame is performed on the non-attention area. Therefore, delay of video images caused in H.265 in which compression processing is performed between frames is less likely. Therefore, low-latency distribution of video data can be achieved.

(16) A video distribution method according to another embodiment of the present disclosure includes performing compression processing, by a video transmission device, on video data and transmitting, by the video transmission device, the video data subjected to the compression processing and receiving, by a video reception device, video data subjected to the compression processing from the video transmission device and performing, by the video reception device, decompression processing on the received video data. In the transmitting the video data, of a prescribed attention area within a frame of the video data and a prescribed non-attention area different from the attention area within the frame, the video transmission device performs prescribed compression processing within the frame on the non-attention area and does not perform the prescribed compression processing on the attention area.

This configuration includes the step corresponding to a characteristic processing unit included in the video transport system described above. Therefore, according to this configuration, functions and effects similar to those of the video transport system described above can be achieved.

(17) A video transmission method according to another embodiment of the present disclosure includes performing, of a prescribed attention area within a frame of video data and a prescribed non-attention area different from the attention area within the frame, prescribed compression processing within the frame on the non-attention area and transmitting the video data subjected to the prescribed compression processing to a video reception device.

This configuration includes the step corresponding to the characteristic processing unit included in the video transmission device described above. Therefore, according to this configuration, functions and effects similar to those of the video transmission device described above can be achieved.

(18) A video reception method according to another embodiment of the present disclosure includes receiving video data from a video transmission device, the video data being video data resulting from prescribed compression processing within a frame of the video data on a prescribed non-attention area, of a prescribed attention area within the frame and the non-attention area different from the attention area within the frame, and decompressing the received video data.

This configuration includes the step corresponding to the characteristic processing unit included in the video reception device described above. Therefore, according to this configuration, functions and effects similar to those of the video reception device described above can be achieved.

(19) A computer program according to another embodiment of the present disclosure causes a computer to perform performing, of a prescribed attention area within a frame of video data and a prescribed non-attention area different from the attention area within the frame, prescribed compression processing within the frame on the non-attention area, and transmitting the video data subjected to the prescribed compression processing to a video reception device.

According to this configuration, the computer can function as the video transmission device described above. Therefore, functions and effects similar to those of the video transmission device described above can be achieved.

(20) A computer program according to another embodiment of the present disclosure causes a computer to perform receiving video data from a video transmission device, the video data being video data resulting from prescribed compression processing within a frame of the video data on a prescribed non-attention area, of a prescribed attention area within the frame and the non-attention area different from the attention area within the frame, and decompressing the received video data.

According to this configuration, the computer can function as the video reception device described above. Therefore, functions and effects similar to those of the video reception device described above can be achieved.

### Details of Embodiments of the Present Disclosure

Embodiments of the present disclosure will be described below with reference to the drawings. The embodiments which will be described below each show one preferred specific example of the present disclosure. A numeric value, a shape, a material, a component, a position of arrangement and a form of connection of a component, a step, and an order of steps shown in the embodiments below are merely by way of example, and do not intend to limit the present disclosure. A component not described in an independent claim describing a most generic concept of the present disclosure among components in the embodiments below is described as any component that implements a more preferred form.

The same components have the same reference characters allotted. Since functions and labels thereof are also the same, description thereof will not be provided as appropriate.

### First Embodiment

<Overall Configuration of Video Transport System>

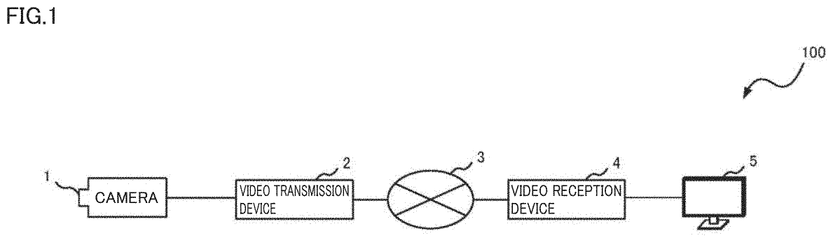

FIG. 1 is a diagram showing an overall configuration of a video transport system according to a first embodiment of the present disclosure.

Referring to FIG. 1, a video transport system 100 includes a camera 1, a video transmission device 2, a video reception device 4, and a display 5.

Camera 1 captures an image of a prescribed object. Camera 1 is, for example, a surveillance camera provided in a facility or the like. Camera 1 may be attached to a mobile body such as heavy equipment or a drone.

Camera 1 takes high-definition video images of an object. Video data includes a plurality of frames. For example, video data of 60 frames per second (fps) include sixty frames per one second.

More specifically, camera 1 generates video data of an object in a resolution of 8K UHDTV, for example, in conformity with the dual green system or the 4:2:2 system. This video data includes image data for each frame.

The rate of transport of video data of 60 fps generated in conformity with the dual green system is, for example, 23.89 Gbps or 19.91 Gbps. The rate of transport of video data generated in conformity with the 4:2:2 system is, for example, 47.78 Gbps or 39.81 Gbps.

Video transmission device 2 transmits video data resulting from shooting by camera 1 to video reception device 4 over a network 3.

Video reception device 4 receives video data from video transmission device 2 and shows the received video data on display 5.

<Configuration of Video Transmission Device 2>

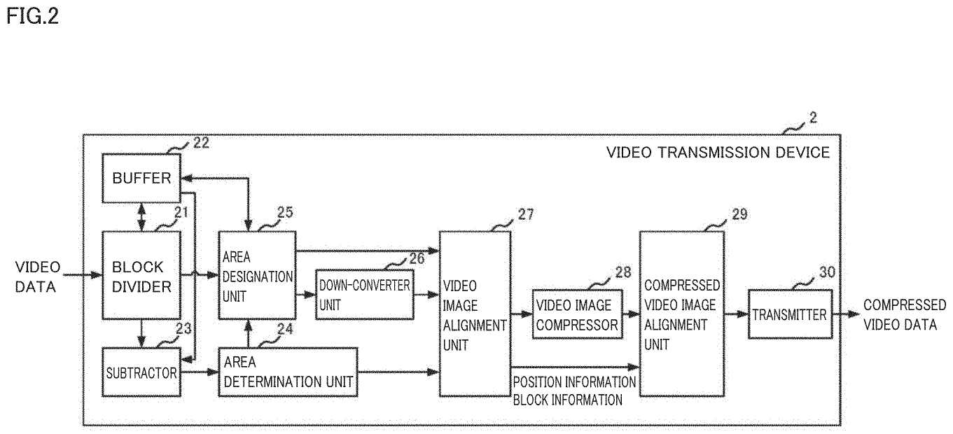

FIG. 2 is a block diagram showing a configuration of video transmission device 2 according to the first embodiment of the present disclosure.

Referring to FIG. 2, video transmission device 2 includes a block divider 21, a buffer 22, a subtractor 23, an area determination unit 24, an area designation unit 25, a down-converter unit 26, a video image alignment unit 27, a video image compressor 28, a compressed video image alignment unit 29, and a transmitter 30.

A part or the entirety of video transmission device 2 is implemented by hardware including an integrated circuit such as an application specific integrated circuit (ASIC) or a field-programmable gate array (FPGA).

Video transmission device 2 can also be implemented by a computer including a central processing unit (CPU), a random access memory (RAM), and a read only memory (ROM). Each processing unit is implemented as a functional component by execution of a computer program on a computing processing device such as a CPU.

Block divider 21 includes a communication interface, and it is a processing unit that receives a frame (which is also referred to as “image data” below) that composes video data resulting from image capture by camera 1 and divides the image data into small blocks of a prescribed size.

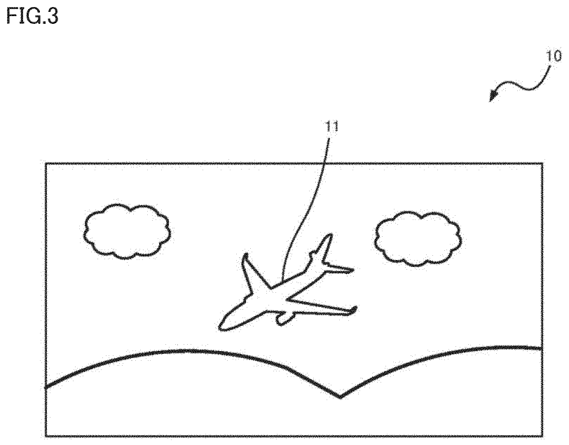

FIG. 3 is a diagram showing exemplary image data. Image data 10 shows, for example, an image of an airplane 11 that flies in the air.

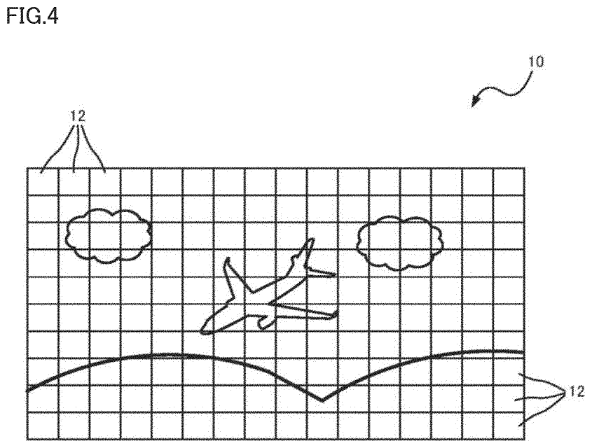

FIG. 4 is a diagram showing exemplary image data 10 after image data 10 shown in FIG. 3 is divided into small blocks. As shown in FIG. 4, image data 10 is divided into small blocks 12 regularly arranged laterally and vertically. The number of small blocks 12 is not limited as illustrated.

Block divider 21 has video data received from camera 1 temporarily stored in buffer 22.

Block divider 21 provides small blocks 12 to subtractor 23 and area designation unit 25 in accordance with a prescribed order.

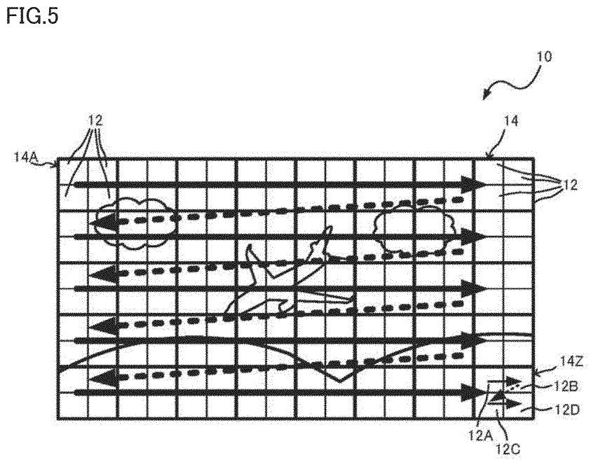

FIG. 5 is a diagram for illustrating an order of output of small blocks 12 from block divider 21 to subtractor 23 and area designation unit 25. As shown in FIG. 5, image data 10 is divided into large blocks 14 regularly arranged laterally and vertically. Each large block 14 is composed of 2×2 small blocks 12. Block divider 21 scans large block 14 to be processed in image data 10 from an upper left large block 14A to a lower right large block 14Z in the order of raster. Block divider 21 scans small blocks 12 to be processed in each large block 14 from an upper left small block to a lower right small block in the order of raster and provides small blocks 12. Block divider 21 scans small blocks in large block 14Z, for example, in the order of a small block 12A a small block 12B a small block 12C a small block 12D, and provides each small block 12 to subtractor 23 and area designation unit 25. The number of small blocks 12 that compose large block 14 is not limited as described above. For example, large block 14 may be composed of 3×3 small blocks 12.

Subtractor 23 sequentially receives small blocks 12 from block divider 21 and performs subtraction processing between small blocks 12 in the order of reception. Specifically, subtractor 23 performs subtraction processing between small block 12 of image data to be compressed that is received from block divider 21 and small block 12 at the same block position of image data that precedes the image data by a prescribed number of frames (for example, one frame).

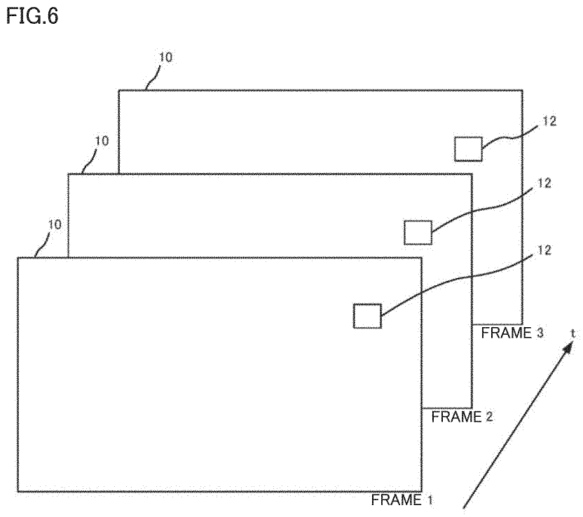

FIG. 6 is a diagram for illustrating subtraction processing. FIG. 6 shows a time sequence of image data 10 that composes video data, and shows a sequence of three temporally continuous pieces of image data 10 from a frame 1 to a frame 3. Image data 10 in frame 1 is oldest and image data 10 in frame 3 is newest. Subtractor 23 is assumed to have received from block divider 21, small block 12 of image data 10 in frame 3 to be compressed. Subtractor 23 reads small block 12 at a position the same as the small block received from block divider 21, from image data 10 in frame 2 that precedes by one frame and is stored in buffer 22. Subtractor 23 calculates a difference in luminance value for each pixel between two small blocks 12 identical in position and different in frame.

For example, it is assumed that small block 12 has a size of m×n pixels and a luminance value of each pixel in small block 12 is expressed as I(t, i, j), where t represents a frame number, (i, j) represents a coordinate within small block 12, and relation of 1≤i≤m and 1≤j≤n is satisfied.

A difference sub between small block 12 having a frame number t and small block 12 having a frame number t−1 is expressed in an Expression 1 below. In the expression, t represents a number of a frame to be compressed. L represents the number of levels of luminance (256 when the luminance value is expressed in eight bits).

$$\begin{matrix}[ Expression 1 ] & \\ sub = {\sum }_{i , j} \vert I ( t , i , j ) - I ( t - 1 , i , j ) \vert / \{ L \times ( m \times n ) \} & ( Expression 1 )\end{matrix}$$

Subtraction processing is not limited to subtraction processing performed between adjacent frames. For example, subtraction processing may be performed between image data 10 in frame 1 and image data 10 in frame 3 distant by two frames from frame 1.

Area determination unit 24 receives difference sub between small blocks 12 from subtractor 23, and determines whether to set small block 12 to which attention is paid as an attention area or a non-attention area based on comparison between difference sub and a prescribed threshold value Tsub. Specifically, when an Expression 2 below is satisfied, small block 12 is determined as the attention area, and when the expression is not satisfied, it is determined as the non-attention area. In other words, area determination unit 24 determines small block 12 large in variation in luminance value between frames as the attention area, and determines small block 12 small in variation in luminance value as the non-attention area.

$$sub >= Tsub \qquad ( Expression 2 )$$

Area determination unit 24 sets as block information, a result of determination as the attention area or the non-attention area, and provides the block information to area designation unit 25 and video image alignment unit 27, together with position information of small block 12 of image data 10. The order of output of small block 12 provided from block divider 21 to subtractor 23 is determined in advance as described above. Therefore, position information of small block 12 is determined based on the order of output. The position of small block 12 is not limited so long as the position of small block 12 of image data 10 can be identified based on the information, and for example, a coordinate at an upper left corner of small block 12 of image data 10 or the order of output of small block 12 may be applicable.

Area designation unit 25 provides small block 12 received from block divider 21 to down-converter unit 26 or video image alignment unit 27 based on the block information of small block 12 received from area determination unit 24.

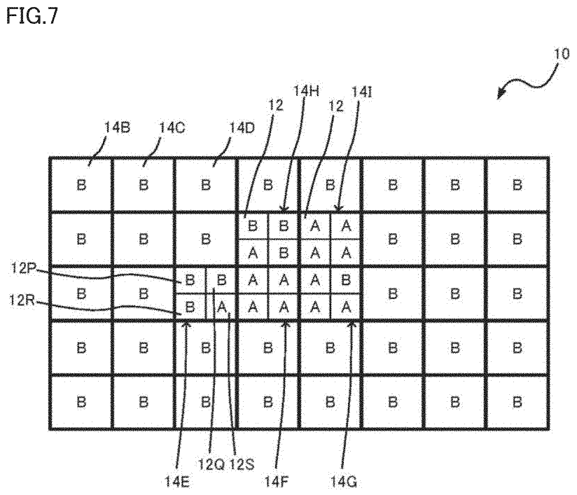

Processing for output of small block 12 by area designation unit 25 will now be described. FIG. 7 is a diagram showing block information for one frame (image data 10) determined by area determination unit 24.

Large block 14 (for example, large blocks 14B to 14D) labeled only as B indicates that all (four) small blocks 12 included in large block 14 are each a non-attention area (which is also referred to as a “block B” below).

Large block 14 (for example, large blocks 14E to 14I) divided into four small blocks 12 refers to large block 14 composed only of the attention area (which is also referred to as a “block A” below) or large block 14 in which blocks A and B are mixed. For example, large block 14E is composed of four small blocks 12P to 12S where blocks A and B are mixed. Large block 14F is composed of four small blocks 12 consisting of blocks A.

When large block 14 includes even a single block A, area designation unit 25 provides all small blocks 12 included in that large block 14 to video image alignment unit 27. For example, small block 12S shown in FIG. 7 is determined as block A. Therefore, area designation unit 25 provides all small blocks 12P to 12S included in large block 14E to which small block 12S belongs to video image alignment unit 27.

When all small blocks 12 in large block 14 are blocks B, area designation unit 25 provides all small blocks 12 included in that large block 14 to down-converter unit 26. For example, small blocks 12 in large block 14B shown in FIG. 7 are all blocks B. Therefore, area designation unit 25 provides all small blocks 12 included in large block 14B to down-converter unit 26.

Down-converter unit 26 functions as a compression processing unit that performs compression processing as prescribed preprocessing, and performs down-conversion processing for reducing the size of small block 12 received from area designation unit 25 as preprocessing compression processing.

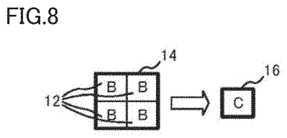

FIG. 8 is a diagram showing exemplary down-conversion processing. For example, down-converter unit 26 receives four small blocks 12 included in large block 14 to be processed from area designation unit 25. Down-converter unit 26 performs down-conversion processing for vertically and laterally reducing large block 14 to ½ to generate a downsized block 16 (which is also referred to as a “block C” below). Down-converter unit 26 provides generated downsized block 16 to video image alignment unit 27.

Video image alignment unit 27 receives small block 12 or downsized block 16 from area designation unit 25 or down-converter unit 26, and provides small block 12 or downsized block 16 as being arranged in the order corresponding to output from area designation unit 25. Video image alignment unit 27 provides position information and block information of small block 12 or downsized block 16 to compressed video image alignment unit 29.

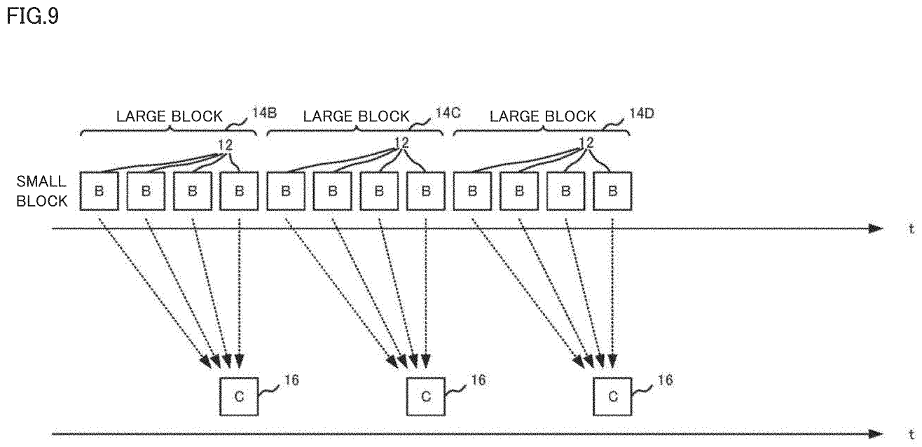

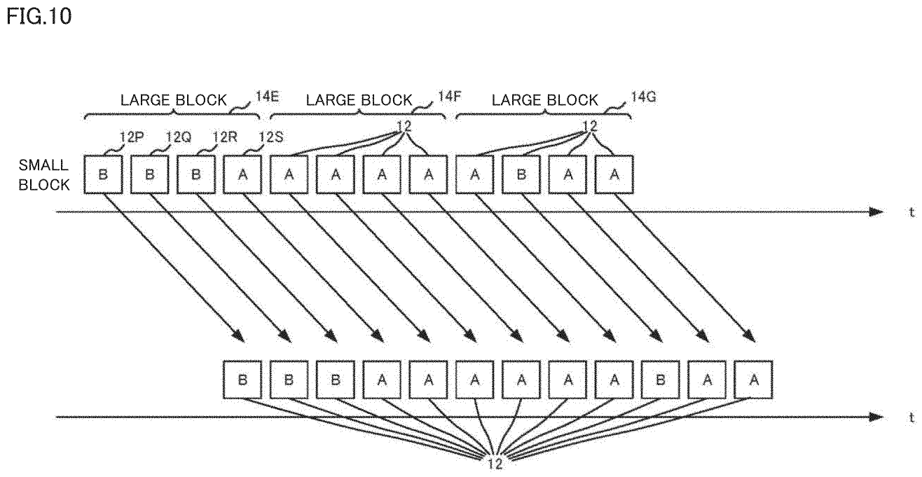

Processing performed by area designation unit 25, down-converter unit 26, and video image alignment unit 27 will be described below. FIG. 9 is a diagram for illustrating processing performed on large blocks 14B to 14D in image data 10 in FIG. 7 by way of example. FIG. 10 is a diagram for illustrating processing performed on large blocks 14E to 14G in image data 10 in FIG. 7 by way of example.

The upper part of FIG. 9 shows the order of small blocks 12 provided from area designation unit 25 and the lower part of FIG. 9 shows the order of small blocks 12 provided to video image alignment unit 27. This is also applicable to FIG. 10.

Referring to FIG. 9, area designation unit 25 successively receives four small blocks 12 included in large block 14B from block divider 21 in the order of raster. Area designation unit 25 receives block information of four small blocks 12 from area determination unit 24 in the order of raster. Area designation unit 25 determines that four small blocks 12 are all blocks B based on the block information. Therefore, area determination unit 25 provides four blocks B to down-converter unit 26. Down-converter unit 26 receives four blocks B from area designation unit 25 and performs down-conversion processing on these blocks B to generate downsized block 16 (block C). Down-converter unit 26 provides generated block C to video image alignment unit 27.

Video image alignment unit 27 provides downsized block 16 received from down-converter unit 26 to video image compressor 28 in the order of reception. Video image alignment unit 27 provides position information and block information of downsized block 16 to compressed video image alignment unit 29. Position information of downsized block 16 is position information of any small block 12 (for example, at the upper left corner) included in large block 14B from which downsized block 16 is generated. Block information of downsized block 16 is information indicating that downsized block 16 is generated by down-conversion processing of small block 12 (for example, information indicating block C).

Area designation unit 25, down-converter unit 26, and video image alignment unit 27 successively perform similar processing also for large block 14C and large block 14D.

Referring to FIG. 10, area designation unit 25 successively receives four small blocks 12P to 12S included in large block 14E from block divider 21 in the order of raster. Area designation unit 25 receives block information of four small blocks 12P to 12S from area determination unit 24 in the order of raster. Area designation unit 25 determines that small block 12S which is block A is included in four small blocks 12 based on the block information. Therefore, area designation unit 25 provides four small blocks 12P to 12S to video image alignment unit 27 in the order of raster.

Video image alignment unit 27 provides small blocks 12P to 12S received from area designation unit 25 to video image compressor 28 in the order of reception. Video image alignment unit 27 provides position information and block information of small blocks 12P to 12S to compressed video image alignment unit 29. Position information and block information of small blocks 12P to 12S are the same as those received from area determination unit 24.

Area designation unit 25 successively performs similar processing also on large blocks 14F and 14G.

Video image compressor 28 receives small block 12 (block A or B) or downsized block 16 (block C) from video image alignment unit 27. Video image compressor 28 performs video image compression processing for video images as a whole on the blocks, in the order of received blocks, and provides compressed blocks to compressed video image alignment unit 29. Video image compression processing is reversible compression processing or lossy compression processing. Reversible compression processing refers to processing for compression such that a compressed block can return to an uncompressed block, and it is generally low in compression rate and the compression rate greatly varies depending on an image. Specifically, a compression rate of an image close to noise is low, whereas the compression rate of a sharp image is high. Lossy compression processing refers to processing for compression such that a compressed block cannot return to an uncompressed block. Lossy compression processing by using an algorithm called visually lossless compression or visually reversible compression, however, is a method of compression with visual reversibility. Therefore, in the present embodiment, for example, video image compressor 28 performs lossy compression processing based on visually reversible compression.

Compressed video image alignment unit 29 receives a compressed block from video image compressor 28. Compressed video image alignment unit 29 adds position information and block information obtained from video image alignment unit 27 to a block in the order of received blocks, and provides a resultant block to transmitter 30.

Transmitter 30 includes a communication interface, and encodes a compressed block to which position information and block information are added to transmit the compressed block to video reception device 4 as compressed video data.

<Configuration of Video Reception Device 4>

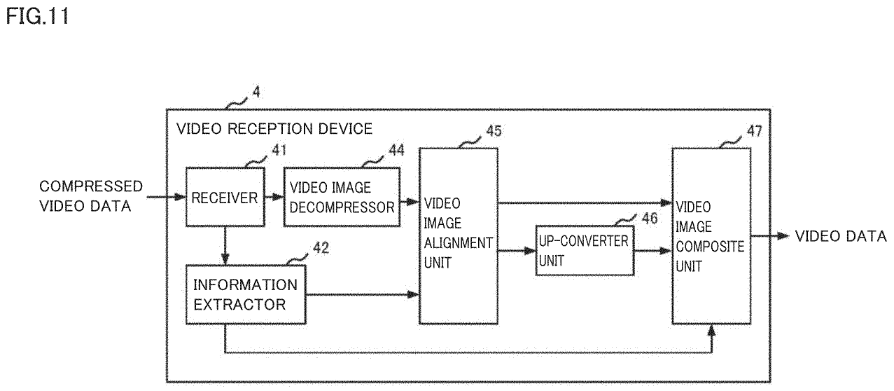

FIG. 11 is a block diagram showing a configuration of video reception device 4 according to the first embodiment of the present disclosure.

Referring to FIG. 11, video reception device 4 includes a receiver 41, an information extractor 42, a video image decompressor 44, a video image alignment unit 45, an up-converter unit 46, and a video image composite unit 47.

A part or the entirety of video reception device 4 is implemented by hardware including an integrated circuit such as an ASIC or an FPGA.

Video reception device 4 can also be implemented by a computer including a CPU, a RAM, and a ROM. Each processing unit is implemented as a functional component by execution of a computer program on a computing processing device such as a CPU.

Receiver 41 includes a communication interface. Receiver 41 receives compressed video data for one frame from video transmission device 2 and decodes received data. The decoded data includes a compressed block to which position information and block information are added. Receiver 41 successively provides compressed blocks to information extractor 42 and video image decompressor 44.

Information extractor 42 receives the compressed blocks from receiver 41. Information extractor 42 extracts position information and block information from the blocks and provides them to video image alignment unit 45 and video image composite unit 47.

Video image decompressor 44 successively receives the compressed blocks from receiver 41. Video image decompressor 44 performs video image decompression processing on the compressed blocks in the order of reception and provides decompressed blocks to video image alignment unit 45. Video image decompression processing is reversible decompression processing or lossy decompression processing. Video image decompressor 44 performs decompression processing corresponding to compression processing by video image compressor 28 of video transmission device 2. Specifically, when video image compressor 28 performs reversible compression processing, video image decompressor 44 performs reversible decompression processing corresponding to that processing, and when video image compressor 28 performs lossy compression processing, video image decompressor 44 performs lossy decompression processing corresponding to that processing.

Video image alignment unit 45 successively receives decompressed blocks from video image decompressor 44. Video image alignment unit 45 receives position information and block information of the decompressed blocks from information extractor 42. Video image alignment unit 45 aligns decompressed blocks based on the position information. In other words, video image alignment unit 45 aligns decompressed blocks in the order of raster. Video image alignment unit 45 determines a type of the decompressed block based on the block information. When the decompressed block is block A or block B, video image alignment unit 45 provides that block to video image composite unit 47. When the decompressed block is block C, video image alignment unit 45 provides that block to up-converter unit 46.

Up-converter unit 46 receives block C from video image alignment unit 45 and performs up-conversion processing for vertically and laterally enlarging block C by two times. In other words, up-converter unit 46 performs processing for enhancing a resolution of block C. Up-converter unit 46 provides the generated up-converted block to video image composite unit 47.

Video image composite unit 47 receives blocks from video image alignment unit 45 or up-converter unit 46 and receives position information of the blocks from information extractor 42. Video image composite unit 47 composites image data by arranging each block at a position indicated in position information. Video image composite unit 47 provides video data to display 5 by successively providing video data to display 5.

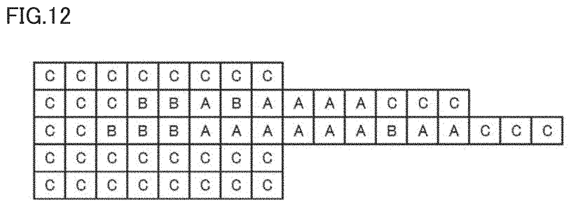

Processing performed by video image alignment unit 45, up-converter unit 46, and video image composite unit 47 will now be described with reference to specific examples. FIG. 12 is a diagram showing exemplary compressed video data. FIG. 12 shows data for one frame resulting from compression of image data 10 shown in FIG. 7.

Large blocks 14 in the first row of image data 10 in FIG. 7 are totally composed of B blocks. Therefore, the first row of compressed video data shown in FIG. 12 is totally composed of C blocks. This is also applicable to fourth and fifth rows of image data 10.

First three large blocks 14 in the second row of image data 10 are totally composed of B blocks. Therefore, first three pieces in the second row of compressed video data are composed of C blocks. Fourth large block 14H and fifth large block 14I in the second row of image data 10 each include one or more A blocks. Therefore, a fourth piece to an eleventh piece in the second row of compressed video data are the same as small blocks 12 included in large blocks 14H and 14I. Sixth to eighth large blocks 14 in the second row of image data 10 are totally composed of B blocks. Therefore, last three pieces in the second row of compressed video data are composed of C blocks.

The third row of compressed video data is also similarly composed in correspondence with the third row of image data 10.

Video image alignment unit 45 receives blocks that compose video data resulting from decompression of compressed video data shown in FIG. 12 in the order of position shown in FIG. 12. Specifically, video image alignment unit 45 receives blocks from block C at the upper left to block C at the lower right in the order of raster.

When video image alignment unit 45 receives block C, it provides block C to up-converter unit 46. Up-converter unit 46 up-converts block C and provides the up-converted block to video image composite unit 47. When video image alignment unit 45 receives block A or B, it provides the block to video image composite unit 47.

Video image composite unit 47 generates image data 10 in which blocks are aligned as shown in FIG. 7 by compositing block A or B received from video image alignment unit 45 and up-converted block C received from up-converter unit 46 with each other.

<Flow of Processing by Video Transport System 100>

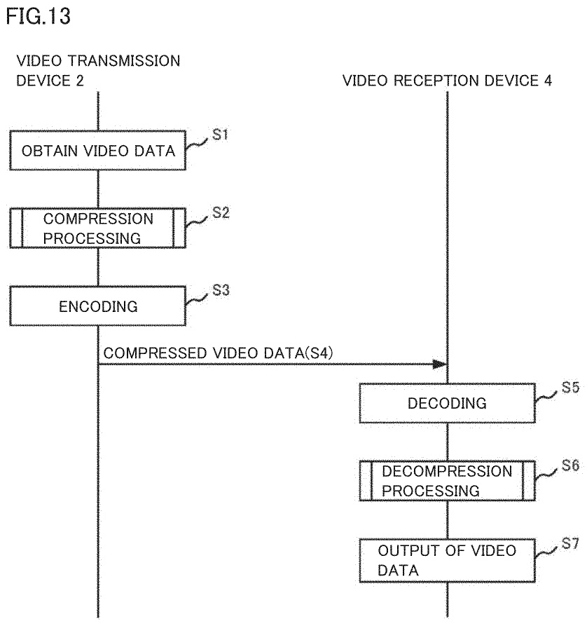

FIG. 13 is a sequence diagram showing an exemplary procedure of processing by video transport system 100.

Referring to FIG. 13, video transmission device 2 obtains video data from camera 1 (S1).

Video transmission device 2 performs compression processing on the obtained video data for each piece of image data that composes the video data (S2). Details of compression processing will be described later.

Video transmission device 2 encodes compressed video data (S3).

Video transmission device 2 transmits encoded compressed video data to video reception device 4 and video reception device 4 receives the data (S4).

Video reception device 4 decodes received compressed video data (S5).

Video reception device 4 performs decompression processing on the compressed video data for each frame (S6). Details of decompression processing will be described later.

Video reception device 4 provides decompressed video data to display 5 (S7).

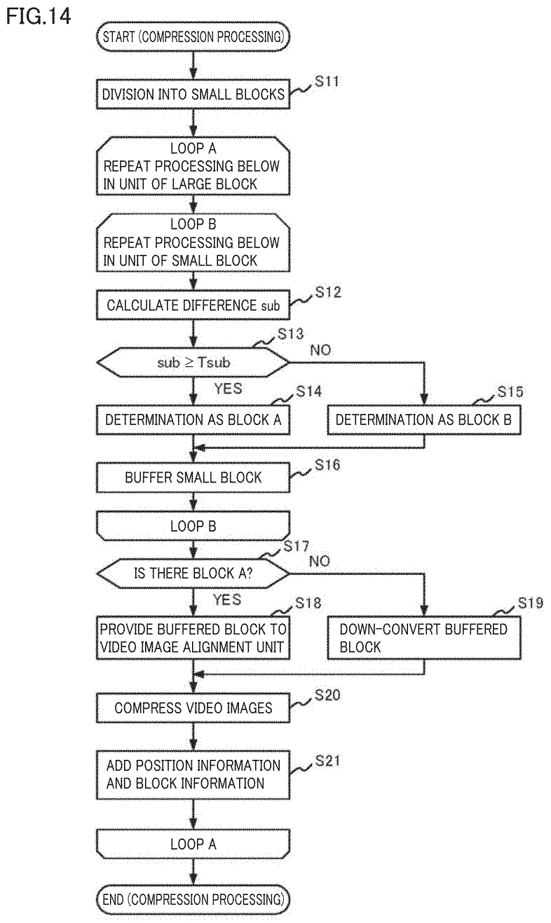

Compression processing (step S2 in FIG. 13) will now be described. FIG. 14 is a flowchart showing details of compression processing (step S2 in FIG. 13).

Block divider 21 divides image data into small blocks 12 of a prescribed size (S11). Image data 10 is thus divided into small blocks 12 as shown in FIG. 4.

Video transmission device 2 repeatedly performs a loop B which will be described later and steps S17 to S21 in a unit of large block 14 in the order of raster shown in FIG. 5 (a loop A).

Video transmission device 2 repeatedly performs on each large block 14, steps S12 to S16 which will be described later in a unit of small block 12 in the order of raster (loop B).

In other words, subtractor 23 calculates difference sub between small blocks 12 in frames in accordance with the Expression 1 (S12).

Area determination unit 24 compares difference sub with threshold value Tsub in accordance with the Expression 2 (S13).

When the Expression 2 is satisfied (YES in S13), area determination unit 24 determines small block 12 as block A and provides block information and position information of small block 12 to area designation unit 25 and video image alignment unit 27 (S14). When the Expression 2 is not satisfied (NO in S13), area determination unit 24 determines small block 12 as block B and provides block information and position information of small block 12 to area designation unit 25 and video image alignment unit 27 (S15).

Area designation unit 25 has small block 12, a type of which has been determined, buffered in buffer 22 (S16).

After processing in loop B, area designation unit 25 determines whether or not block A is included in large block 14 based on block information of small block 12 received from area determination unit 24 (S17). When block A is included (YES in S17), area designation unit 25 provides four small blocks 12 included in large block 14 buffered in buffer 22 to video image alignment unit 27 (S18).

When block A is not included (NO in S17), area designation unit 25 provides four small blocks 12 included in large block 14 buffered in buffer 22 to down-converter unit 26. Down-converter unit 26 down-converts four small blocks 12 and provides downsized block 16 to video image alignment unit 27 (S19).

Video image alignment unit 27 provides small block 12 or downsized block 16 received from area designation unit 25 or down-converter unit 26 to video image compressor 28, and video image compressor 28 performs video image compression processing on that block (S20).

Compressed video image alignment unit 29 adds position information and block information to a compressed block and provides the resultant block to transmitter 30 (S21).

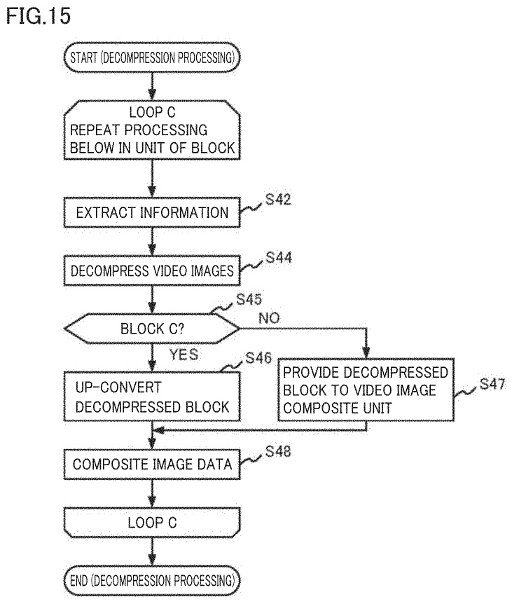

Decompression processing (step S6 in FIG. 13) will now be described. FIG. 15 is a flowchart showing details of decompression processing (step S6 in FIG. 13).

Video reception device 4 repeatedly performs steps S42 to S48 below in a unit of a compressed block that composes compressed video data (a loop C).

Information extractor 42 extracts position information and block information from the compressed block and provides the extracted information to video image alignment unit 45 and video image composite unit 47 (S42).

Video image decompressor 44 performs video image decompression processing on the compressed block and provides the decompressed block to video image alignment unit 45 (S44).

Video image alignment unit 45 determines whether or not the decompressed block is block C (S45). When the decompressed block is block C (YES in S45), video image alignment unit 45 provides that block to up-converter unit 46. Up-converter unit 46 up-converts block C and provides the up-converted block to video image composite unit 47 (S46).

When the decompressed block is block A or B (NO in S45), video image alignment unit 45 provides that block to video image composite unit 47 (S47).

Video image composite unit 47 receives the block from video image alignment unit 45 or up-converter unit 46, and composites image data by arranging each block at a position indicated in position information (S48).

<Effect etc. in First Embodiment>

As described above, according to the first embodiment of the present disclosure, down-conversion processing is not performed on the attention area within the frame of video data but down-conversion processing is performed on the non-attention area, and then compressed video data can be transmitted. Therefore, identicalness with original video images is held in the attention area. The non-attention area is subjected to down-conversion processing within the frame. Therefore, delay in video images caused in H.265 in which compression processing is performed between frames is less likely. Therefore, low-latency distribution of video data can be achieved.

The attention area and the non-attention area are designated in a unit of a block. Therefore, down-conversion processing can be performed in a unit of a block. Compression processing can thus quickly be performed.

In the first embodiment, when all small blocks 12 in large block 14 are B blocks, large block 14 is down-converted. When large block 14 includes even a single B block, however, large block 14 may be down-converted.

### Second Embodiment

In the first embodiment, when A block and B block are mixed in a single large block 14, small blocks 12 in large block 14 are not down-converted. In contrast, in a second embodiment, video transport system 100 that generates, for such a large block 14, compressed video data including an A block that is not down-converted and a C block resulting from down-conversion of large block 14 will be described.

Video transport system 100 is similar in configuration to that in the first embodiment.

A procedure of processing by video transport system 100 is similar to that in the first embodiment. Compression processing (step S2 in FIG. 13), however, is different from that in the first embodiment.

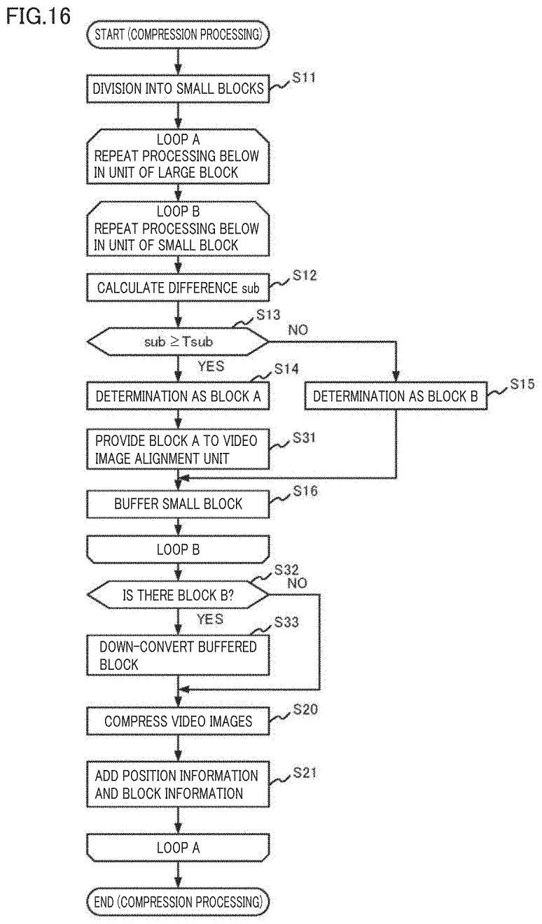

FIG. 16 is a flowchart showing details of compression processing (step S2 in FIG. 13) performed by video transmission device 2. Processing similar to that in the flowchart shown in FIG. 14 has the same step number allotted.

After processing in step S14, area designation unit 25 provides block A to video image alignment unit 27 (S31).

After processing in loop B, area designation unit 25 determines whether or not large block 14 includes block B based on block information of small block 12 received from area determination unit 24 (S32). When block B is included (YES in S32), area designation unit 25 provides four small blocks 12 included in large block 14 buffered in buffer 22 to down-converter unit 26. Down-converter unit 26 down-converts four small blocks 12 and provides downsized block 16 to video image alignment unit 27 (S33).

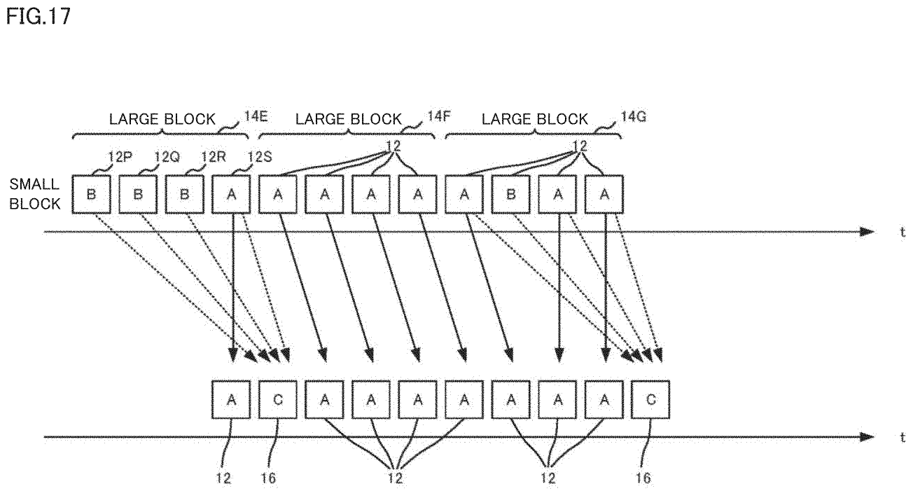

Processing performed by area designation unit 25, down-converter unit 26, and video image alignment unit 27 will be described below. FIG. 17 is a diagram for illustrating processing for large blocks 14E to 14G in image data 10 in FIG. 7 by way of example. The upper part in FIG. 17 shows the order of small blocks 12 provided from area designation unit 25 and the lower part of FIG. 17 shows the order of small blocks 12 provided to video image alignment unit 27.

Referring to FIG. 17, area designation unit 25 successively receives four small blocks 12P to 12S included in large block 14E from block divider 21 in the order of raster. Area designation unit 25 receives block information of four small blocks 12P to 12S from area determination unit 24 in the order of raster. Area designation unit 25 determines that small block 12S that falls under block A is included and provides small block 12S to video image alignment unit 27. Area designation unit 25 determines that block B is included in four small blocks 12. Therefore, area designation unit 25 provides small blocks 12P to 12S to down-converter unit 26 in the order of raster. Down-converter unit 26 receives small blocks 12P to 12S and performs down-conversion processing onto these small blocks to generate downsized block 16 (block C). Down-converter unit 26 provides generated block C to video image alignment unit 27.

Video image alignment unit 27 provides downsized block 16 received from area designation unit 25 to video image compressor 28 in the order of reception. Video image alignment unit 27 provides position information and block information of downsized block 16 to compressed video image alignment unit 29. The position information and the block information of downsized block 16 are the same as those received from area determination unit 24.

Area designation unit 25 successively performs similar processing also on large blocks 14F and 14G.

A flow of decompression processing (step S6 in FIG. 13) is similar to that shown in FIG. 15. A part of image data composite processing (step S48 in FIG. 15), however, is different. Specifically, as shown in FIG. 17, in the second embodiment, an A block and a C block may be generated for one large block 14E. Therefore, an area of the A block and an area of a block resulting from up-conversion of a C block overlap with each other. Therefore, when an up-converted block is arranged at a position of the A block after the A block is arranged, video image composite unit 47 leaves the A block and arranges the up-converted block at a position except for the area of the A block. Overwriting of the A block with the up-converted block is thus prevented.

### Third Embodiment

In the first or second embodiment, threshold value Tsub of difference sub for determining whether small block 12 is defined as the attention area or the non-attention area is fixed. Threshold value Tsub, however, can also be variable. In a third embodiment, an example in which threshold value Tsub is varied depending on a condition of transport of compressed video data will be described. Specifically, the number of attention areas is decreased by increasing threshold value Tsub when the condition of transport becomes poor, so that a data size of compressed video data is reduced.

Video transport system 100 is similar in configuration to that in the first embodiment.

A procedure of processing by video transport system 100 is similar to that in the first embodiment. Compression processing (step S2 in FIG. 13), however, is different from that in the first embodiment.

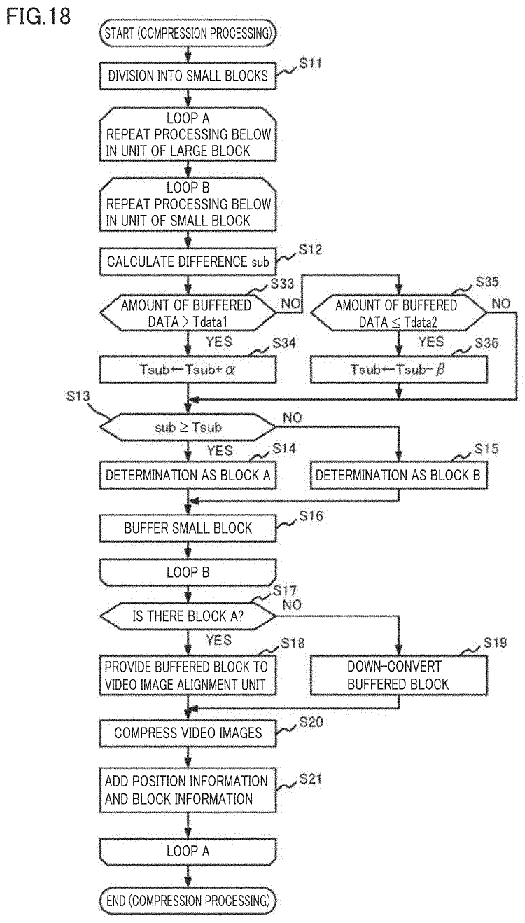

FIG. 18 is a flowchart showing details of compression processing (step S2 in FIG. 13) performed by video transmission device 2. Processing similar to that in the flowchart shown in FIG. 14 has the same step number allotted.

After processing in step S12, area determination unit 24 determines whether or not an amount of unprocessed buffered data accumulated in buffer 22 is larger than a threshold value Tdata1 (S33). Block divider 21 has video data received from camera 1 successively stored in buffer 22. When transport of compressed video data from video transmission device 2 to video reception device 4 is delayed, however, the amount of unprocessed buffered data in buffer 22 increases. In other words, the amount of unprocessed buffered data serves as transmission condition information indicating a condition of transmission of video data.

When the amount of unprocessed buffered data is larger than Tdata1 (YES in S33), area determination unit 24 increases threshold value Tsub by a (a positive constant). Generation of the attention area is thus less likely.

When the amount of unprocessed buffered data is equal to or smaller than Tdata1 (NO in S33), area determination unit 24 determines whether or not the amount of unprocessed buffered data is equal to or smaller than a threshold value Tdata2 (S35). Tdata2 represents a value smaller than Tdata1. When the amount of unprocessed buffered data is equal to or smaller than threshold value Tdata2 (YES in S35), block divider 21 decreases threshold value Tsub by β (a positive constant). The attention area can thus more readily be generated.

α may be equal to or different from β.

When the amount of unprocessed buffered data is larger than threshold value Tdata2 (NO in S35) or after processing in S34 or S36, processing in step S13 or later is performed.

According to the third embodiment, when the amount of unprocessed buffered data increases, the number of small blocks 12 determined as the attention area can be reduced. As the rate of transport of video data is lowered, the amount of unprocessed buffer data increases. In other words, according to the second embodiment, the size of video data to be transported can be reduced by reducing the size of the attention area when the rate of transport of video data is lowered. Low-latency distribution of video data can thus be achieved.

### Fourth Embodiment

The attention area is determined based on difference sub between small blocks 12 in the first to third embodiments. In a fourth embodiment, a user designates the attention area.

Video transport system 100 is similar in configuration to that in the first embodiment. The configuration of video transmission device 2 and video reception device 4 is partially different from that in the first embodiment.

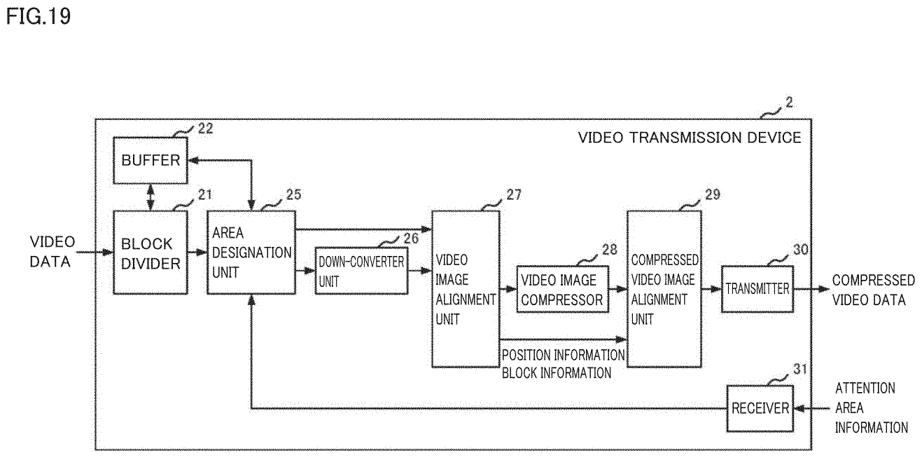

FIG. 19 is a block diagram showing a configuration of video transmission device 2 according to the fourth embodiment of the present disclosure.

Referring to FIG. 19, video transmission device 2 according to the fourth embodiment includes block divider 21, buffer 22, area designation unit 25, down-converter unit 26, video image alignment unit 27, video image compressor 28, compressed video image alignment unit 29, transmitter 30, and a receiver 31. Processing units 21, 22, and 25 to 30 are similar to those shown in FIG. 2.

Receiver 31 receives attention area information from video reception device 4. Attention area information is information indicating a position of the attention area in the frame of video data. Attention area information may include, for example, a coordinate of an upper left corner of the attention area or may be a number brought in correspondence with a position of small block 12. Attention area information may include position information of the non-attention area instead of position information of the attention area. Attention area information may include both of position information of the attention area and position information of the non-attention area.

Area designation unit 25 provides small blocks 12 resulting from division by block divider 21 to down-converter unit 26 or video image alignment unit 27 based on attention area information received by receiver 31. In other words, area designation unit 25 provides small blocks 12 in the attention area to video image alignment unit 27 and provides small blocks 12 in the non-attention area to down-converter unit 26.

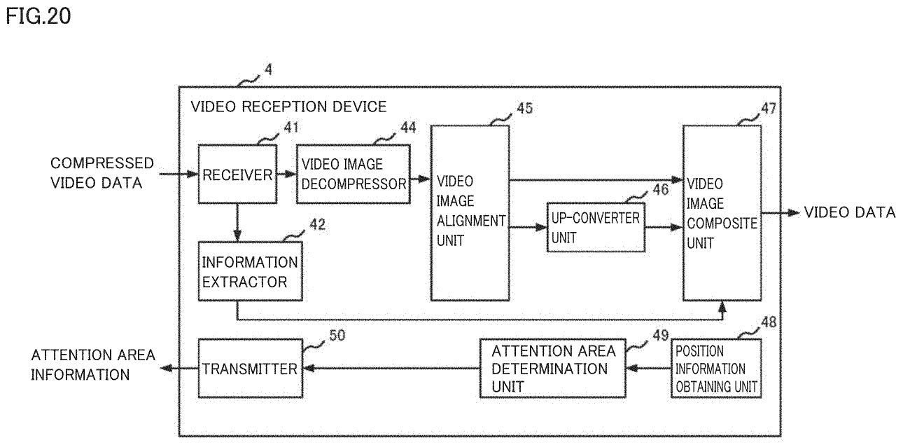

FIG. 20 is a block diagram showing a configuration of video reception device 4 according to the fourth embodiment of the present disclosure.

Referring to FIG. 20, video reception device 4 according to the fourth embodiment includes receiver 41, information extractor 42, video image decompressor 44, video image alignment unit 45, up-converter unit 46, video image composite unit 47, a position information obtaining unit 48, an attention area determination unit 49, and a transmitter 50. Processing units 41 to 47 are similar to those shown in FIG. 11.

Position information obtaining unit 48 obtains position information of the attention area entered by a user by operating such input means as a mouse or a keyboard and provides obtained position information to attention area determination unit 49. Position information obtaining unit 48 may obtain position information of the attention area from a processing device connected to video reception device 4. For example, the processing device receives video data from video reception device 4 and determines position information of the attention area by performing image processing based on the video data or by using artificial intelligence. The processing device provides the determined position information of the attention area to video reception device 4 so that position information obtaining unit 48 of video reception device 4 obtains the position information.

Attention area determination unit 49 receives position information from position information obtaining unit 48 and generates attention area information for designating the attention area. For example, attention area determination unit 49 generates attention area information including the coordinate of the upper left corner of small block 12 in the attention area or a number brought in correspondence with the position of small block 12 in the attention area. Attention area determination unit 49 provides the generated attention area information to transmitter 50.

Transmitter 50 receives attention area information from attention area determination unit 49 and transmits the attention area information to video transmission device 2.

A flow of processing by video transport system 100 will now be described.

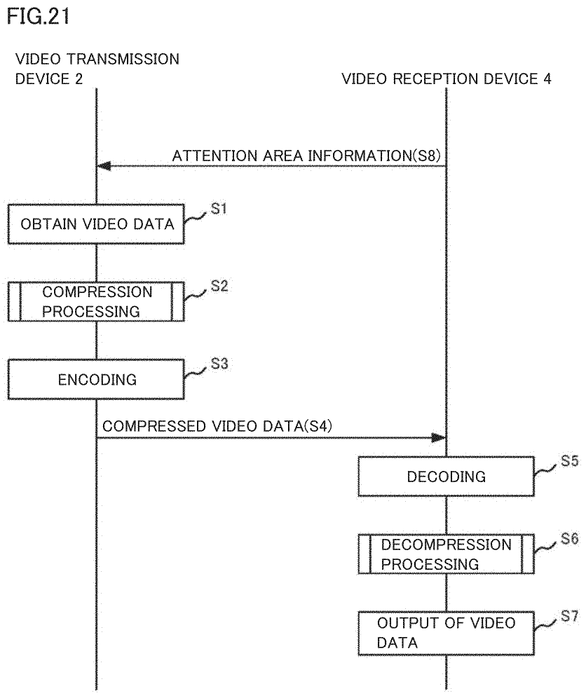

FIG. 21 is a sequence diagram showing an exemplary procedure of processing by video transport system 100.

Referring to FIG. 21, video reception device 4 transmits attention area information generated based on a user input to video transmission device 2 and video transmission device 2 receives the attention area information (S8).

After processing in step S8, processing in steps S1 to S7 similar to that shown in FIG. 13 is performed. Some of contents of compression processing (step S2) are different.

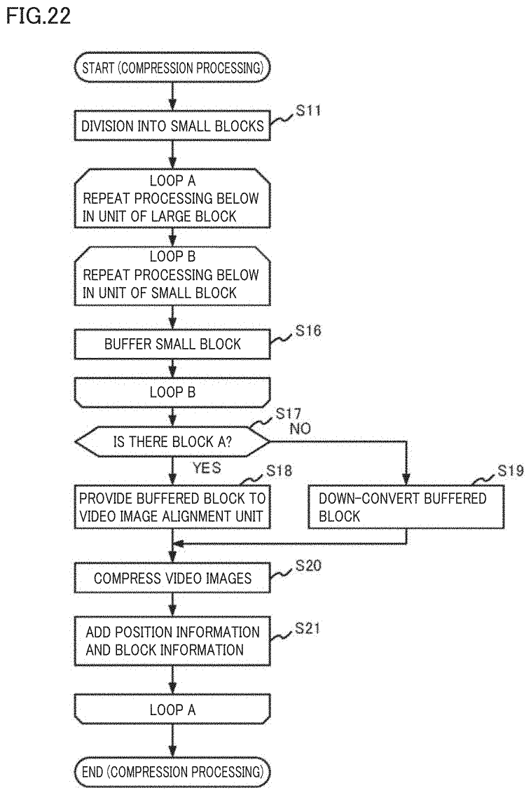

FIG. 22 is a flowchart showing details of compression processing (step S2 in FIG. 21). The flowchart shown in FIG. 22 is the same as the flowchart showing details of compression processing shown in FIG. 14 except for processing for determining which of block A and block B small block 12 falls under (steps S12 to S15 in FIG. 14).

Specifically, video transmission device 2 can determine which of block A and block B small block 12 falls under based on attention area information received from video reception device 4. Therefore, processing in steps S12 to S15 in FIG. 14 does not have to be performed.

According to the fourth embodiment, low-latency distribution of video data identicalness of which with original video images is held in an area designated by the user can be achieved. For example, when video data is used in surveillance applications in which an area to be monitored is known in advance, surveillance processing can efficiently be performed as the user designates the area to be monitored as the attention area.

### Fifth Embodiment

In a fifth embodiment, an example in which an attention area is determined based on a line of sight of a user will be described.

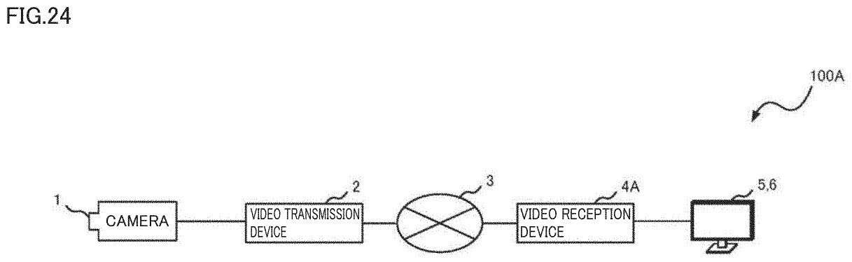

FIG. 24 is a diagram showing an overall configuration of a video transport system according to the fifth embodiment of the present disclosure.

Referring to FIG. 24, a video transport system 100A includes camera 1, video transmission device 2, a video reception device 4A, and display 5 and a camera 6.

Camera 1 and display 5 are similar in configuration to those shown in the first embodiment.

Video transmission device 2 is similar in configuration to that shown in the fourth embodiment.

Similarly to video reception device 4 described in the fourth embodiment, video reception device 4A receives video data from video transmission device 2 and shows received video data on display 5. Video reception device 4A, however, is partially different in configuration from video reception device 4. The configuration of video reception device 4A will be described later.

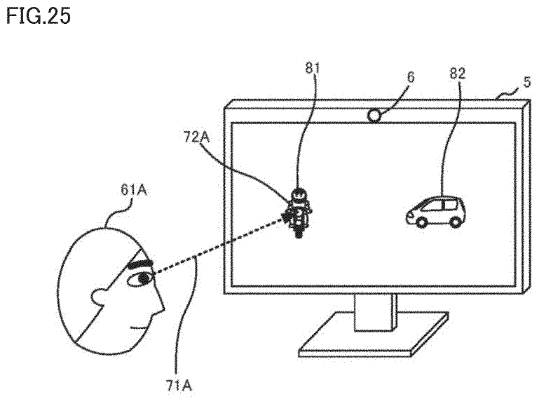

FIG. 25 is a diagram showing exemplary display 5 and exemplary camera 6.

Display 5 is a device for showing video images on a frame of a liquid crystal display, an organic electroluminescence (EL) display, or the like.

Camera 6 is contained in a bezel of display 5. Camera 6 may be provided separately from display 5. For example, camera 6 may be used as being attached to display 5. Positional relation between the frame of display 5 and camera 6 is assumed as being known in advance. Camera 6 is provided at a position where it can shoot a face of a user 61A who looks at the frame of display 5. In particular, camera 6 is provided at a position where it can capture an image of eyes of user 61A.

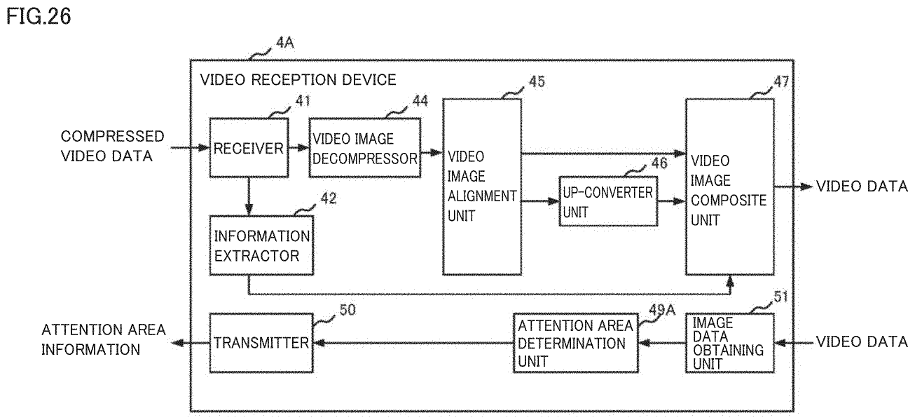

FIG. 26 is a block diagram showing a configuration of video reception device 4A according to the fifth embodiment of the present disclosure.

Referring to FIG. 26, video reception device 4A according to the fifth embodiment includes a video data obtaining unit 51 and an attention area determination unit 49A instead of position information obtaining unit 48 and attention area determination unit 49 in the configuration of video reception device 4 according to the fourth embodiment shown in FIG. 20.

Video data obtaining unit 51 receives video data resulting from image capture by camera 6 from camera 6 and provides received video data to attention area determination unit 49A.

Attention area determination unit 49A receives video data from video data obtaining unit 51, and determines a line-of-sight position of a user on the frame of display 5 based on the video data. For example, it is assumed that user 61A turns his/her eyes in a line-of-sight direction 71A and looks at a motorcycle 81 shown on the frame of display 5 as shown in FIG. 25. A known technique is available for detection of line-of-sight direction 71A. For example, attention area determination unit 49A detects from video data of user 61A, a part of eyes that does not move (a reference point) and a part of the eyes that moves (a moving point). An inner corner of the eye of user 61A is defined as the reference point and an iris of user 61A is defined as the moving point. Attention area determination unit 49A detects an orientation of the line of sight of user 61A with an orientation of an optical axis of camera 6 being defined as the reference, based on the position of the moving point with respect to the reference point (see, for example, NPL 2). Attention area determination unit 49A determines an intersection between line-of-sight direction 71A and the frame as a line-of-sight position 72A. Line-of-sight position 72A is expressed, for example, by a coordinate of video data shown on the frame.

Attention area determination unit 49A determines the attention area within video data shown on display 5 based on a determined line-of-sight position 72A.

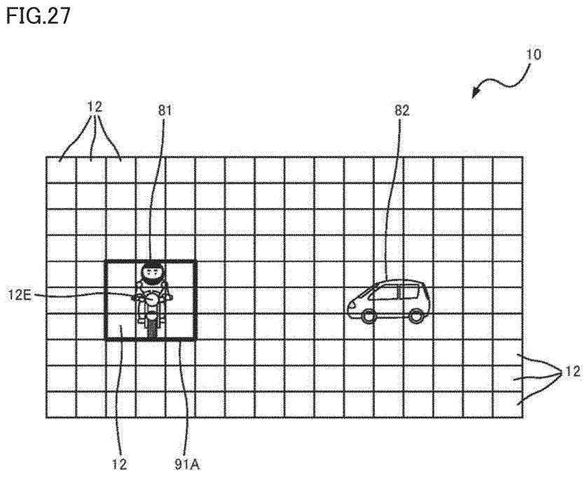

FIG. 27 is a diagram for illustrating a method of determining an attention area. FIG. 27 shows an example in which image data 10 shown on the frame of display 5 is divided into a plurality of small blocks 12. User 61A is assumed to look, for example, at the inside of small block 12E. In other words, line-of-sight position 72A of user 61A is assumed to be within small block 12E. Attention area determination unit 49A determines that line-of-sight position 72A is included in small block 12E based on the coordinate of line-of-sight position 72A. Attention area determination unit 49A determines an area composed of a plurality of small blocks 12 including small block 12 as an attention area 91A. For example, attention area determination unit 49A determines an area composed of small block 12E and eight proximate small blocks 12 adjacent to small block 12E as attention area 91A.

The size of attention area 91A is merely by way of example, and not limited as illustrated. A shape or a color of an object can accurately be observed by the sense of sight of humans in a range called a central vision within an angle of approximately one to two degrees from the line-of-sight direction. Therefore, when an approximate distance from user 61A to display 5 is known, the central vision on the frame can also be defined. Therefore, the central vision around line-of-sight position 72A may be determined as attention area 91A.

Similarly to attention area determination unit 49, attention area determination unit 49A generates attention area information for designating the attention area and provides generated attention area information to transmitter 50.

A flow of processing by video transport system 100A will now be described.

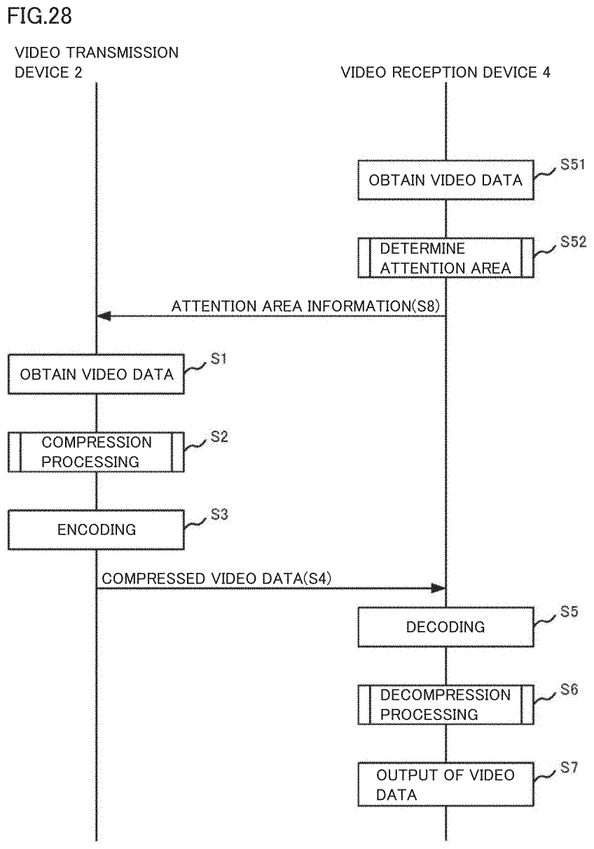

FIG. 28 is a sequence diagram showing an exemplary procedure of processing by video transport system 100A.

Referring to FIG. 28, video reception device 4A obtains video data including an image of eyes of user 61A who looks at the frame of display 5 from camera 6 (S51).

Video reception device 4A determines the attention area of user 61A in video data shown on display 5 based on the obtained video data.

Video reception device 4 transmits attention area information indicating the determined attention area to video transmission device 2 and video transmission device 2 receives the attention area information (S8).

After processing in step S8, processing in steps S1 to S7 as shown in FIG. 13 is performed.

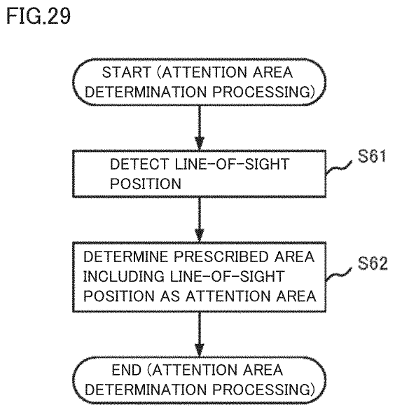

FIG. 29 is a flowchart showing details of attention area determination processing (step S52 in FIG. 28).

Referring to FIG. 29, attention area determination unit 49A of video reception device 4 determines line-of-sight position 72A of user 61A on the frame based on the video data obtained in step S51 (S61).

Attention area determination unit 49A determines a prescribed area including line-of-sight position 72A as attention area 91A (S62).

An exemplary manner of use of video transport system 100A will now be described. An example in which camera 1 is attached to a mobile body (for example, a drone) will be described below.

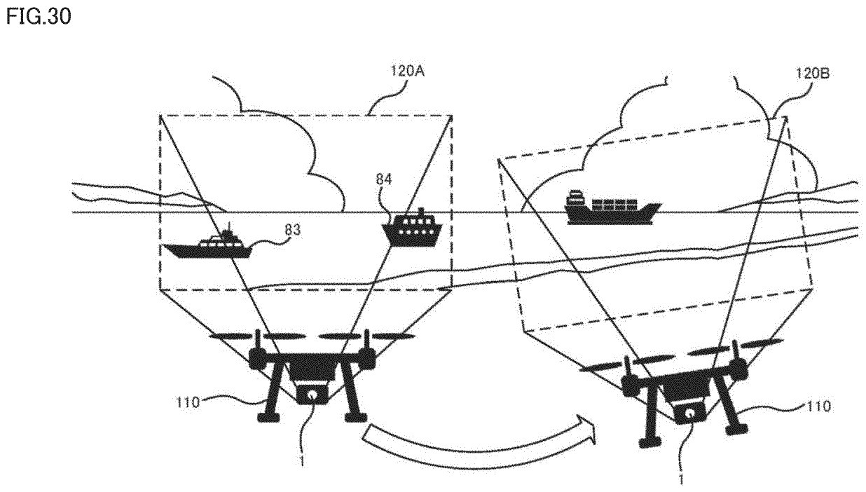

FIG. 30 is a diagram schematically showing video shooting by a drone. Referring to FIG. 30, camera 1 for taking video images of surroundings is mounted on a drone 110. Drone 110 takes video images with camera 1 while it flies as being remotely controlled by a user. For example, drone 110 takes video images over an image capture range 120A and thereafter moves to another position by an operation by the user to take video images over an image capture range 120B.

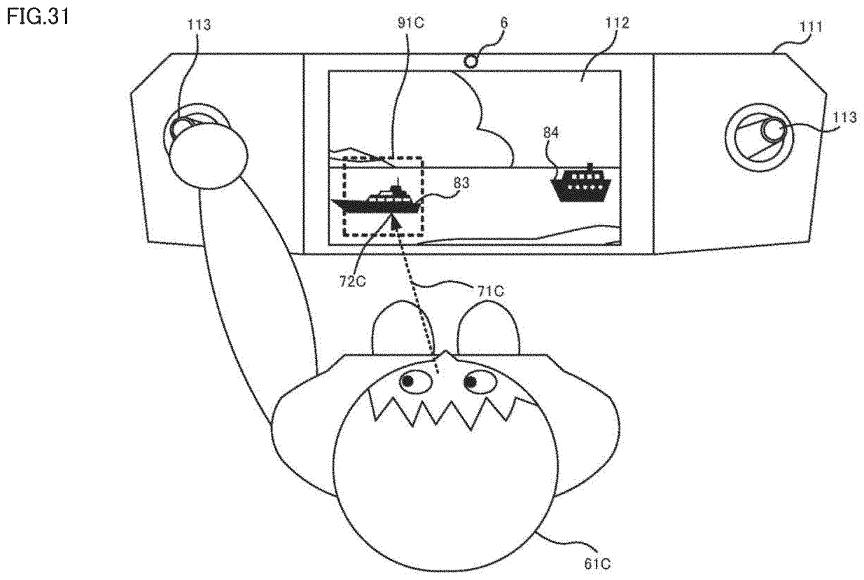

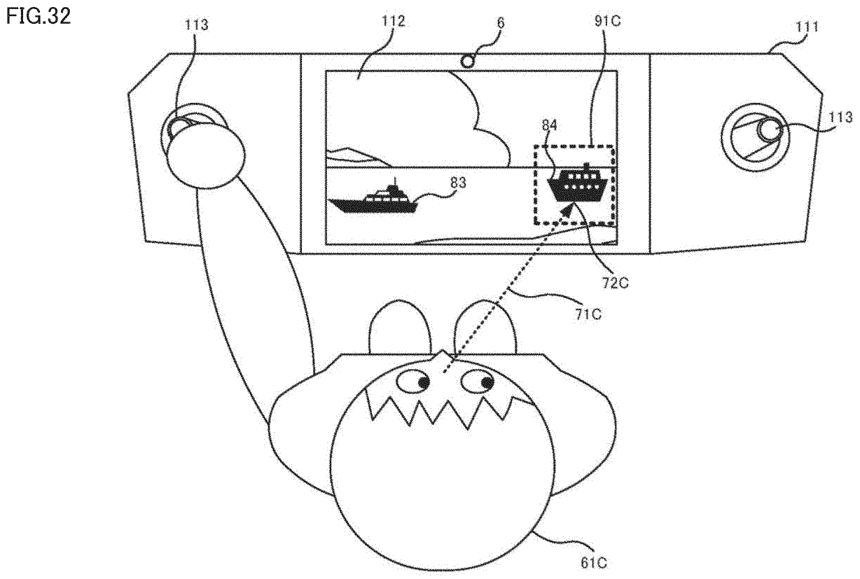

FIGS. 31 and 32 are diagrams schematically showing a controller for operating drone 110 and a user who operates the controller.

Referring to FIG. 31, a controller 111 is assumed to contain video reception device 4A. Controller 111 includes a frame 112 for showing video images, a joystick 113 for maneuvering drone 110, and camera 6 that shoots a user 61C who operates controller 111. As user 61C operates joystick 113, a direction of travel or a speed of drone 110 can be changed.

It is assumed that video images over image capture range 120A are shown on frame 112. It is assumed that user 61C turns his/her eyes into a line-of-sight direction 71C to watch a ship 83 shown on frame 112, and a line of sight of user 61C falls on a line-of-sight position 72C. In this case, video reception device 4A determines a prescribed area including line-of-sight position 72C as an attention area 91C. Ship 83 watched by the user thus holds identicalness with original video images. An area other than attention area 91C on frame 112 is defined as the non-attention area, which is subjected to down-conversion processing.

Referring to FIG. 32, it is assumed that user 61C changes his/her line-of-sight direction 71C to watch a ship 84 shown on frame 112 and the line of sight of user 61C falls on line-of-sight position 72C. In this case, video reception device 4A determines a prescribed area including line-of-sight position 72C as attention area 91C. Ship 84 watched by the user thus holds identicalness with original video images. An area other than attention area 91C on frame 112 is defined as the non-attention area, which is subjected to down-conversion processing.

According to the fifth embodiment, for example, an area in the vicinity of the line-of-sight position of the user within the frame of display 5 is defined as the attention area, and an area other than that is defined as the non-attention area. Therefore, in an area within the frame watched by the user, identicalness with original video images is held, whereas an area not watched by the user is subjected to prescribed compression processing. Therefore, compression and low-latency distribution of video data can be achieved without giving uncomfortable feeling to a user who looks at the frame.

### Sixth Embodiment

In the fifth embodiment, an example in which the attention area is determined depending on a line-of-sight position of a user is described. In a sixth embodiment, an example in which the attention area is fixed based on a time period for which a line-of-sight position is maintained. When a user is gazing the same position on the frame for a long period of time, the user may be highly interested in that position. Therefore, even though the user averts his/her eyes from the position of gaze, the user may be highly likely to look at that position again. Therefore, when the same position is gazed for a long period of time, the attention area is fixed.

The video transport system according to the sixth embodiment is configured as in the fifth embodiment. Processing by attention area determination unit 49A of video reception device 4 is different from that in the fifth embodiment.

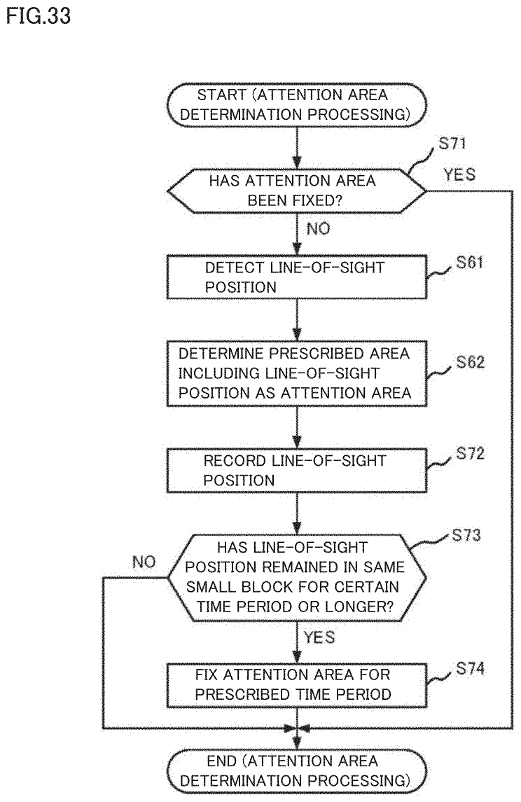

FIG. 33 is a flowchart showing details of attention area determination processing (step S52 in FIG. 28) according to the sixth embodiment of the present disclosure.

Referring to FIGS. 27 and 33, attention area determination unit 49A of video reception device 4 determines whether or not attention area 91A has been fixed (S71). When attention area 91A has been fixed (YES in S71), attention area determination processing (step S52 in FIG. 28) ends.

When attention area 91A has not been fixed (NO in S71), attention area determination unit 49A performs processing in steps S61 and S62. This processing is similar to that shown in FIG. 29.

Attention area determination unit 49A has information on the line-of-sight position detected in step S61 recorded in a not-shown storage, together with information on time of detection of the line-of-sight position (S72).

Attention area determination unit 49A determines whether or not the line-of-sight position has remained in the same small block for a certain period of time or longer based on information on the line-of-sight position and time of detection recorded in the storage (S73). For example, attention area determination unit 49A determines whether or not a state that the line-of-sight position is present within small block 12E lasts for a certain period of time or longer.

When a result of determination is true (YES in S73), attention area determination unit 49A thereafter fixes attention area 91A for a prescribed time period (S74).

When the result of determination is false (NO in S73), attention area determination unit 49A quits attention area determination processing (step S52 in FIG. 28).

According to the sixth embodiment, as the user gazes a prescribed position in the frame or a position in the vicinity of the prescribed position, the attention area can be fixed for a prescribed period of time. A position in the vicinity of the prescribed position refers, for example, to a position belonging to a small block where the prescribed position is located. Thus, even when the user momentarily averts his/her line of sight after gazing, the attention area remains fixed. Therefore, when the user thereafter moves the line of sight back to the original position, the user can immediately watch video images identicalness of which with original video images is held. Definition of the vicinity of the prescribed position is not limited as above.

### Seventh Embodiment

In the fifth and sixth embodiments, an example in which there is a single user is described. In a seventh embodiment, an example in which there are a plurality of users will be described.

The video transport system according to the seventh embodiment is configured as in the fifth embodiment. The seventh embodiment is different from the fifth embodiment in that a plurality of attention areas are determined by attention area determination unit 49A of video reception device 4A.

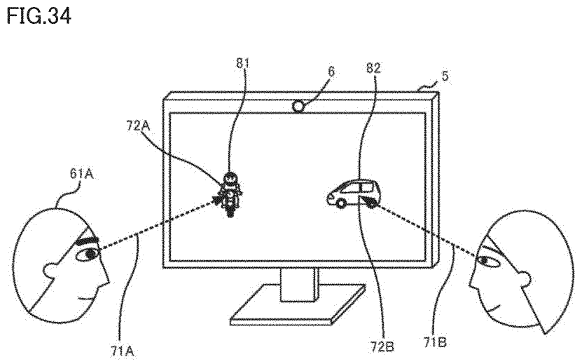

FIG. 34 is a diagram showing exemplary display 5 and exemplary camera 6. Display 5 and camera 6 shown in FIG. 34 are similar to those shown in FIG. 25. In the seventh embodiment, unlike the fifth embodiment, a plurality of users are assumed to look at the frame of display 5. For example, user 61A and a user 61B are assumed to look at the frame of display 5. For example, user 61A is assumed to turn his/her eyes in line-of-sight direction 71A and to watch motorcycle 81 shown on the frame. User 61B is assumed to turn his/her eyes in a line-of-sight direction 71B and to watch a car 82 shown on the frame.

Attention area determination unit 49A of video reception device 4A receives video data from video image data obtaining unit 51 and determines a line-of-sight position of the user on the frame of display 5 based on the video data. How to determine the line-of-sight position is the same as in the fifth embodiment. In the example in FIG. 34, attention area determination unit 49A determines an intersection between line-of-sight direction 71A and the frame as a line-of-sight position 72A of user 61A. Attention area determination unit 49A determines an intersection between line-of-sight direction 71B and the frame as line-of-sight position 72B of user 61B. Line-of-sight position 72A and line-of-sight position 72B are expressed, for example, by coordinates of video data shown on the frame.

Attention area determination unit 49A determines the attention area within video data shown on display 5 based on determined line-of-sight position 72A and line-of-sight position 72B.

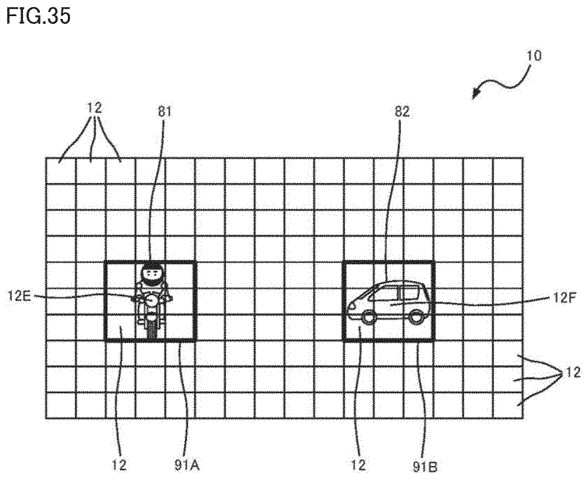

FIG. 35 is a diagram for illustrating a method of determining an attention area. FIG. 35 shows an example in which image data 10 shown on the frame of display 5 is divided into a plurality of small blocks 12. User 61A is assumed to look, for example, at the inside of small block 12E. In other words, line-of-sight position 72A of user 61A is assumed to be present within small block 12E. Attention area determination unit 49A determines that line-of-sight position 72A is included in small block 12E based on the coordinate of line-of-sight position 72A. Attention area determination unit 49A determines an area composed of a plurality of small blocks 12 including small block 12E as attention area 91A. For example, attention area determination unit 49A determines an area composed of small block 12E and eight proximate small blocks 12 adjacent to small block 12E as attention area 91A.

User 61B is assumed to look, for example, at the inside of small block 12F. In other words, line-of-sight position 72B of user 61B is assumed to be present within small block 12F. Attention area determination unit 49A determines that line-of-sight position 72B is included in small block 12F based on the coordinate of line-of-sight position 72B. Attention area determination unit 49A determines an area composed of a plurality of small blocks 12 including small block 12F as an attention area 91B. For example, attention area determination unit 49A determines an area composed of small block 12F and eight proximate small blocks 12 adjacent to small block 12F as attention area 91B.

The size of attention area 91A and the size of attention area 91B are by way of example, and not limited as illustrated. A shape or a color of an object can accurately be observed by the sense of sight of humans in a range called a central vision within an angle of approximately one to two degrees from the line-of-sight direction. Therefore, when an approximate distance from user 61A or 61B to display 5 is known, the central vision on the frame can also be defined. Therefore, the central visions around line-of-sight positions 72A and 72B may be determined as attention areas 91A and 91B, respectively.

Thus, in video reception device 4A, an area other than attention area 91A and attention area 91B on the frame is defined as the non-attention area, which is subjected to down-conversion processing.

According to the fourth embodiment, the attention area is determined for each user based on the line-of-sight position of the user. Therefore, even though a plurality of users are looking at different positions on the same frame, an area in the vicinity of the line-of-sight position of each user is defined as the attention area and identicalness with original video images is held in each attention area. Therefore, uncomfortable feeling is not given to the plurality of users.

Though line-of-sight positions of the plurality of users are determined based on video data resulting from image capture by camera 6 in the fourth embodiment, camera 6 may be provided for each user. For example, in the example shown in FIG. 34, camera 6 for image capture of user 61A and camera 6 for image capture of user 61B may be provided. Attention area determination unit 49A determines the attention area based on video data resulting from image capture by each camera 6.

### Eighth Embodiment

In the embodiments described above, a frame of video data is divided into the attention area and the non-attention area. In an eighth embodiment, an example in which the non-attention area is further divided into two types of non-attention areas will be described.

The video transport system according to the seventh embodiment is similar in configuration to that in the fifth embodiment. The eighth embodiment is different from the fifth embodiment in that attention area determination unit 49A of video reception device 4A determines two types of non-attention areas.

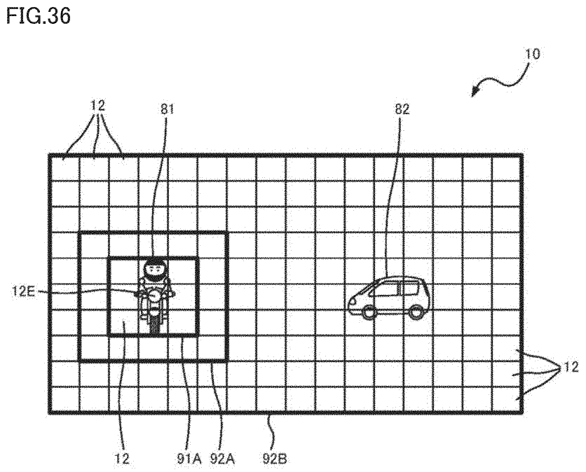

FIG. 36 is a diagram for illustrating a method of determining an attention area and a non-attention area. FIG. 36 shows an example in which image data 10 shown on the frame of display 5 is divided into a plurality of small blocks 12.

As in the fifth embodiment, attention area determination unit 49A determines attention area 91A based on line-of-sight position 72A of user 61A. Then, attention area determination unit 49A determines an area adjacent to attention area 91A as a non-attention area 92A. For example, attention area determination unit 49A determines sixteen small blocks 12 arranged around attention area 91A as non-attention area 92A. Furthermore, attention area determination unit 49A determines an area other than attention area 91A and non-attention area 92A of image data 10 as a non-attention area 92B.

Attention area determination unit 49A generates attention area information for designating attention area 91A, non-attention area 92A, and non-attention area 92B and provides generated attention area information to transmitter 50. Transmitter 50 transmits the attention area information to video transmission device 2.

Receiver 31 of video transmission device 2 receives attention area information from video reception device 4A and provides the attention area information to area designation unit 25.

Area designation unit 25 provides small blocks 12 in attention area 91A to video image alignment unit 27 based on the attention area information received by receiver 31 and provides small blocks 12 in non-attention area 92A and non-attention area 92B to down-converter unit 26. At this time, area designation unit 25 provides identification information (information for identifying non-attention area 92A and non-attention area 92B) of the non-attention area to down-converter unit 26.

Down-converter unit 26 performs down-conversion processing on small blocks 12 with a compression rate of small blocks 12 being varied based on the identification information of the non-attention area. In other words, down-converter unit 26 determines the compression rate such that small block 12 corresponding to non-attention area 92A is lower in compression rate than small block 12 corresponding to non-attention area 92B and performs down-conversion processing on small blocks 12 based on the determined compression rates. Relation of the compression rate with non-attention area 92A and non-attention area 92B may be set in advance.

According to the eighth embodiment, compression processing can be performed in such a manner that the compression rate is lower for non-attention area 92A closer to the center of the field of view of the user in the non-attention area and the compression rate is higher for non-attention area 92B more distant from the center. Therefore, low-latency distribution of video data can be achieved while sudden change in how video images look at a portion of boundary between the attention area and the non-attention area is prevented.

The type of the non-attention area is not limited to the two types, and three or more types of non-attention areas may be provided. In this case, the compression rate is desirably lower for the non-attention area closer to attention area 91A.

Area determination unit 24 of video transmission device 2 shown in FIG. 2 may determine a plurality of types of non-attention areas similarly to attention area determination unit 49A.

Attention area determination unit 49 of video reception device 4 shown in FIG. 20 may determine a plurality of types of non-attention areas similarly to attention area determination unit 49A.

[First Modification]

Though a difference between small blocks 12 is calculated in accordance with the Expression 1 in the embodiments described above, the method of calculating a difference is not limited as such. For example, a peak signal-to-noise ratio (PSNR) between small blocks 12 may be adopted as a difference between small blocks 12. In this case, as the PSNR is higher, two small blocks 12 are more similar to each other, whereas as the PSNR is lower, two small blocks 12 are less similar to each other. Therefore, video transmission device 2 determines small block 12 as block A (attention area) when the PSNR is lower than a prescribed threshold value, and determines small block 12 as block B (non-attention area) when the PSNR is higher than the prescribed threshold value.

[Second Modification]

Though the attention area is determined based on the difference between small blocks 12 in the first to third embodiments, the method of determining the attention area is not limited as such. For example, when camera 1 is attached to a drone, video transmission device 2 may determine the attention area based on a direction of travel of the drone. For example, small block 12 where surroundings in a direction of travel of the drone are shown may be determined as the attention area. The direction of travel of the drone may be received from a control device of the drone. Alternatively, the direction of travel of the drone may be found based on movement of a subject in an image. For example, when the subject in the image moves to the left with camera 1 being attached to a front surface of the drone, the drone can be determined as traveling to the right. Movement of the subject can be found, for example, by calculating an optical flow by image processing.

According to the second modification, low-latency distribution of video data identicalness of which with original video images is held in the attention area determined based on the direction of travel of the drone can be achieved. Thus, for example, the drone can fly in a stable manner. An object to which camera 1 is attached is not limited to the drone, and the camera may be attached to another mobile body such as heavy equipment.

[Third Modification]

When video data includes an image of an object of visual inspection, an area including a portion to be inspected of the object may be defined as the attention area. The attention area may be designated by a user in accordance with the method shown in the fourth embodiment or by a processing device connected to video reception device 4.

According to a third modification, low-latency distribution of video data identicalness of which with original video images is held in a portion to be inspected of an object of visual inspection can be achieved. Therefore, visual inspection of the object can be conducted with less delay.

[Fourth Modification]

Though small blocks 12 are categorized into any of the attention area and the non-attention area in the embodiments and the modifications, areas into which small blocks 12 are categorized are not limited to these two types of areas.

For example, small blocks 12 may be categorized into any of the attention area, a peripheral area, and a non-transport area. The peripheral area refers to an area located around the attention area (for example, an area adjacent to the attention area). The non-transport area refers to an area other than the attention area and the peripheral area in the area within a frame.

The peripheral area is an area around the attention area, although it is out of the range of the attention area. Therefore, though detailed video image information is not required for the peripheral area, video image information to such an extent that a user can recognize an object is required. Therefore, video transmission device 2 is controlled to perform down-conversion processing on the peripheral area as the non-attention area described above. Thus, an amount of data transport from video transmission device 2 to video reception device 4 can be reduced while certain visual recognizability is secured for the non-attention area. Video transmission device 2 does not perform down-conversion processing on the attention area as in the embodiments described above.

Video transmission device 2 does not transport small blocks 12 belonging to the non-transport area to video reception device 4. Therefore, an amount of data transport from video transmission device 2 to video reception device 4 can be reduced. As small blocks 12 belonging to the non-transport area are not transported, video transmission device 2 does not have to perform down-conversion processing on the non-transport area. Therefore, an amount of processing in video transmission device 2 can be reduced.

Small block 12 may be categorized into four or more areas.

[Fifth Modification]

In the first embodiment described above, when all small blocks 12 included in a single large block 14 are B blocks, that large block 14 is subjected to down-conversion processing to generate a C block (FIG. 9). When one large block 14 includes even a single A block, that large block 14 is not subjected to down-conversion processing (FIG. 10).

In contrast, all large blocks 14 included in each piece of image data that composes video data may be subjected to down-conversion processing and thereafter small block 12 not to be subjected to down-conversion processing may be determined.

Specifically, referring to FIG. 2, block divider 21 successively divides image data into large blocks 14 and provides large blocks 14 to area designation unit 25.

Area designation unit 25 receives large blocks 14 from block divider 21 and provides large blocks 14 to down-converter unit 26.

Down-converter unit 26 performs down-conversion processing on large blocks 14 received from block divider 21 to generate C blocks.

Video image alignment unit 27 provides the C blocks to video image compressor 28 and provides position information and block information of the C blocks to compressed video image alignment unit 29.

Video image compressor 28 performs video image compression processing on the C blocks received from video image alignment unit 27 and provides the resultant C blocks to compressed video image alignment unit 29.

Compressed video image alignment unit 29 receives compressed blocks from video image compressor 28. Compressed video image alignment unit 29 adds the position information and the block information obtained from video image alignment unit 27 to the compressed blocks in the order of reception of the compressed blocks and provides the resultant blocks to transmitter 30.

Transmitter 30 includes a communication interface, and encodes the compressed blocks to which the position information and the block information are added and transmits them as compressed video data to video reception device 4.

Through processing so far, compressed video data resulting from down-conversion processing of large blocks 14 that compose image data is transmitted to video reception device 4.

Thereafter, video transmission device 2 performs processing as in the first embodiment onto the same image data. When small blocks 12 that compose large block 14 are all B blocks, processing for that large block 14 is not performed. Thus, redundant generation of a C block can be prevented, and only A blocks or B blocks can be transmitted to video reception device 4.

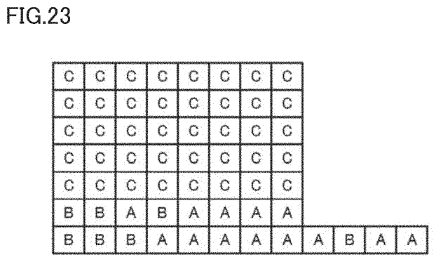

FIG. 23 is a diagram showing exemplary compressed video data. FIG. 23 shows data for one frame resulting from compression of image data 10 shown in FIG. 7. In other words, since large blocks 14 included in image data 10 are all converted to C blocks, compressed video data from the first row to the fifth row are all composed of C blocks.

The sixth row of compressed video data is composed of small blocks 12 included in large blocks 14H and 14I of image data 10.

Furthermore, the seventh row of compressed video data is composed of small blocks 12 included in large blocks 14E to 14G of image data 10.

[Sixth Modification]

Down-converter unit 26 of video transmission device 2 may perform processing for reducing a color depth of each pixel within the non-attention area as prescribed compression processing. For example, the color depth of each pixel in original video data is assumed as full color of 24 bits per pixel (bpp). In other words, luminance of each of RGB of each pixel is expressed by eight bits. Down-converter unit 26 converts luminance of each color into pixel data of 12 bpp expressed by four of eight bits.

Up-converter unit 46 of video reception device 4 converts pixel data in which each color is expressed by four bits into pixel data of 24 bpp in which each color is expressed by eight bits, with higher-order four bits corresponding to four bits of each color and four lower-order bits being padded with 0.

According to the sixth modification, since the color depth of each pixel within the non-attention area can be reduced, low-latency distribution of video data can be achieved. Since the non-attention area corresponds to a periphery of the field of view of the user, the user is less likely to notice reduction in color depth even when it occurs.

[Additional Aspects]

At least a part of the embodiments and the modifications may be combined in any manner.

It should be understood that the embodiments disclosed herein are illustrative and non-restrictive in every respect. The scope of the present disclosure is defined by the terms of the claims rather than the meaning above and is intended to include any modifications within the scope and meaning equivalent to the terms of the claims.

### REFERENCE SIGNS LIST

1 camera
2 video transmission device
3 network
4 video reception device
4A video reception device
5 display
6 camera
10 image data
11 airplane
12 small block
12A small block
12B small block
12C small block
12D small block
12P small block
12Q small block
12R small block
12S small block
14 large block
14A large block
14B large block
14C large block
14D large block
14E large block
14F large block
14G large block
14H large block
14I large block
14Z large block
16 downsized block
21 block divider
22 buffer
23 subtractor
24 area determination unit
25 area designation unit
26 down-converter unit (compression processing unit)
27 video image alignment unit
28 video image compressor
29 compressed video image alignment unit
30 transmitter
31 receiver
41 receiver
42 information extractor
44 video image decompressor (decompressor)
45 video image alignment unit
46 up-converter unit
47 video image composite unit
48 position information obtaining unit
49 attention area determination unit
49A attention area determination unit
50 transmitter
51 video image data obtaining unit
61A user
61B user
61C user
71A line-of-sight direction
71B line-of-sight direction
71C line-of-sight direction
72A line-of-sight position
72B line-of-sight position
72C line-of-sight position
81 motorcycle
82 car
83 ship
84 ship
91A attention area
91B attention area
91C attention area
92A non-attention area
92B non-attention area
100 video transport system
100A video transport system
110 drone
111 controller
112 frame
113 joystick
120A image capture range
120B image capture range

1. A video transport system comprising:
a video transmission device that performs compression processing on video data and transmits the video data subjected to the compression processing; and
a video reception device that receives the video data subjected to the compression processing from the video transmission device and performs decompression processing on the received video data, wherein
of a prescribed attention area within a frame of the video data and a prescribed non-attention area different from the attention area within the frame, the video transmission device performs prescribed compression processing within the frame on the non-attention area and does not perform the prescribed compression processing on the attention area.

2. The video transport system according to claim 1, wherein
the attention area is determined based on a line-of-sight position of a user within the frame.

3. The video transport system according to claim 2, wherein
the attention area is fixed for a prescribed time period based on a time period for which the line-of-sight position is maintained within a prescribed area.

4. The video transport system according to claim 2, wherein
there are a plurality of users, and
the attention area is determined for each user.

5. The video transport system according claim 1, wherein
the video transmission device changes a size of the attention area in accordance with transmission condition information representing a condition of transmission of the video data subjected to the compression processing.

6. The video transport system according to claim 1, wherein
the video data is generated by a camera mounted on a mobile body, and the attention area is determined based on a direction of travel of the mobile body.

7. The video transport system according to claim 1, wherein
the video data includes an image of an object of visual inspection, and
the attention area is an area including a portion to be inspected of the object.

8. The video transport system according to claim 1, wherein
the attention area is determined based on an amount of variation in luminance value between frames of the video data.

9. The video transport system according to claim 1, wherein
the video reception device transmits information for designating the attention area to the video transmission device.

10. The video transport system according to claim 1, wherein
the prescribed compression processing is processing for reducing a color depth of each pixel within the non-attention area.

11. The video transport system according to claim 1, wherein
the frame is divided into a plurality of blocks, and
the attention area and the non-attention area are designated in a unit of a block.

12. The video transport system according to claim 11, wherein
the prescribed compression processing is down-conversion processing for each block within the non-attention area.

13. The video transport system according to claim 1, wherein
the non-attention area includes a plurality of areas different in compression rate in the prescribed compression processing, and an area adjacent to the attention area among the plurality of areas is lowest in compression rate.

14. A video transmission device comprising:
a compression processing unit that performs, of a prescribed attention area within a frame of video data and a prescribed non-attention area different from the attention area within the frame, prescribed compression processing within the frame on the non-attention area; and
a transmitter that transmits the video data subjected to the prescribed compression processing to a video reception device.

15. A video reception device comprising:
a receiver that receives video data from a video transmission device, the video data being video data resulting from prescribed compression processing within a frame of the video data on a prescribed non-attention area, of a prescribed attention area within the frame and the non-attention area different from the attention area within the frame; and
a decompressor that decompresses the video data received by the receiver.

16. A video distribution method comprising:
performing compression processing, by a video transmission device, on video data and transmitting, by the video transmission device, the video data subjected to the compression processing; and
receiving, by a video reception device, the video data subjected to the compression processing from the video transmission device and performing, by the video reception device, decompression processing on the received video data, wherein
in the transmitting the video data, of a prescribed attention area within a frame of the video data and a prescribed non-attention area different from the attention area within the frame, the video transmission device performs prescribed compression processing within the frame on the non-attention area and does not perform the prescribed compression processing on the attention area.

17. A video transmission method comprising:
performing, of a prescribed attention area within a frame of video data and a prescribed non-attention area different from the attention area within the frame, prescribed compression processing within the frame on the non-attention area; and
transmitting the video data subjected to the prescribed compression processing to a video reception device.

18. A video reception method comprising:
receiving video data from a video transmission device, the video data being video data resulting from prescribed compression processing within a frame of the video data on a prescribed non-attention area, of a prescribed attention area within the frame and the non-attention area different from the attention area within the frame; and
decompressing the received video data.

19. A non-transitory computer readable recording medium storing a computer program causing a computer to perform:
performing of a prescribed attention area within a frame of video data and a prescribed non-attention area different from the attention area within the frame, prescribed compression processing within the frame on the non-attention area; and
transmitting the video data subjected to the prescribed compression processing to a video reception device.

20. A non-transitory computer readable recording medium storing a computer program causing a computer to perform:
receiving video data from a video transmission device, the video data being video data resulting from prescribed compression processing within a frame of the video data on a prescribed non-attention area of a prescribed attention area within the frame and the non-attention area different from the attention area within the frame; and
decompressing the received video data.
